(19) United States
(12) Patent Application Publication
(10) Pub. No.: US 2012/0114098 A1
(43) Pub. Date: May 10, 2012

(54) RADIOGRAPHIC APPARATUS AND RADIOGRAPHIC SYSTEM

(75) Inventors: Yuji MIKAMI, Kanagawa (JP); Hiroyasu ISHII, Kanagawa (JP); Naoto IWAKIRI, Kanagawa (JP)

(73) Assignee: FUJIFILM CORPORATION, Tokyo (JP)

(21) Appl. No.: 13/283,153

(22) Filed: Oct. 27, 2011

(30) Foreign Application Priority Data
Oct. 27, 2010 (JP) 2010-241097

(51) Int. Cl. G01N 23/04

(52) U.S. Cl. 378/62

(57) ABSTRACT

A radiographic apparatus includes a first grating, a second grating, a scanning unit, and a radiological image detector. The second grating includes a periodic form that has a period which substantially coincides with a pattern period of a radiological image formed a radiation having passed through the first grating. The scanning unit relatively displaces the radiological image and the second grating to a plurality of relative positions at which phase differences between the radiological image and the second grating are different each other. The radiological image detector detects the radiological image masked by the second grating. The scanning unit includes a driving unit that drives one of the first grating and the second grating relatively to the other in a pattern arrangement direction of the radiological image and a plurality of elastic members that has natural frequencies different from each other.

### CROSS-REFERENCE TO RELATED APPLICATIONS

This application claims the benefit of Japanese Patent Application No. 2010-241097 (filed on Oct. 27, 2010), the entire contents of which are hereby incorporated by reference.

### BACKGROUND

1. Technical Field

The invention relates to a radiographic apparatus and a radiographic system enabling a phase imaging of a photographic subject by using radiation such as X-ray.

2. Related Art

Since X-ray attenuates depending on an atomic number of an element configuring a material and a density and a thickness of the material, it is used as a probe for seeing through an inside of an object to be diagnosed. An imaging using the X-ray is widely spread in fields of medical diagnosis, nondestructive inspection and the like.

In a general X-ray imaging system, an object to be diagnosed is arranged between an X-ray source that irradiates the X-ray and an X-ray image detector that detects the X-ray and a transmission image of the object to be diagnosed is captured. In this case, the X-ray irradiated from the X-ray source toward the X-ray image detector is subject to the quantity attenuation (absorption) depending on differences of the material properties (for example, atomic numbers, densities and thickness) existing on a path to the X-ray image detector and is then incident onto each pixel of the X-ray image detector. As a result, an X-ray absorption image of the object to be diagnosed is detected and captured by the X-ray image detector. As the X-ray image detector, a flat panel detector (FPD) is widely used in addition to a combination of an X-ray intensifying screen and a film and a stimulable phosphor.

However, the X-ray absorption ability is reduced in case of the material consisting of the element having the smaller atomic number. Accordingly, for soft biological tissue or soft material, it is not possible to acquire the shading (contrast) of an image that is enough for the X-ray absorption image. For example, the cartilaginous part and joint fluid configuring an articulation of the body are mostly comprised of water. Thus, since a difference of the X-ray absorption amounts thereof is small, it is difficult to obtain the shading difference.

Regarding the above problem, instead of the intensity change of the X-ray by the object to be diagnosed, a research on an X-ray phase imaging of obtaining an image (hereinafter, referred to as a phase contrast image) based on a phase change (angel change) of the X-ray by the object to be diagnosed has been actively carried out in recent years. In general, it has been known that when the X-ray is incident onto an object, the phase of the X-ray, rather than the intensity of the X-ray, shows the higher interaction. Accordingly, in the X-ray phase imaging of using the phase difference, it is possible to obtain a high contrast image even for a weak absorption material having low X-ray absorption ability. As the X-ray phase imaging, an X-ray imaging system has been recently suggested which uses an X-ray Talbot interferometer having two transmission diffraction gratings (phase type grating and absorption type grating) and an X-ray image detector (for example, refer to JP-A-2008-200359).

The X-ray Talbot interferometer includes a first diffraction grating (phase type grating or absorption type grating) that is arranged at a rear side of an object to be diagnosed, a second diffraction grating (absorption type grating) that is arranged downstream at a specific distance (Talbot interference distance) determined by a grating pitch of the first diffraction grating and an X-ray wavelength, and an X-ray image detector that is arranged at a rear side of the second diffraction grating. The Talbot interference distance is a distance in which the X-ray having passed through the first diffraction grating forms a self-image by the Talbot interference effect. The self-image is modulated by the interaction (phase change) of the object to be diagnosed, which is arranged between the X-ray source and the first diffraction grating, and the X-ray.

In the X-ray Talbot interferometer, a moiré fringe that is generated by superposition (intensity modulation) between the self-image of the first diffraction grating and the second diffraction grating is detected and a change of the moiré fringe by the object to be diagnosed is analyzed, so that phase information of the object to be diagnosed is acquired. As the analysis method of the moiré fringe, a fringe scanning method has been known. According to the fringe scanning method, a plurality of imaging is performed while the second diffraction grating is translation-moved with respect to the first diffraction grating in a direction, which is substantially parallel with a plane of the first diffraction grating and is substantially perpendicular to a grating direction (strip band direction) of the first diffraction grating, with a scanning pitch that is obtained by equally partitioning the grating pitch, and an angle distribution (differential image of a phase shift) of the X-ray refracted from the object to be diagnosed is acquired from changes of respective pixels obtained in the X-ray image detector. Based on the angle distribution, it is possible to acquire a phase contrast image of the object to be diagnosed.

In the X-ray phase imaging as described above, a case is described in which the scanning is performed while moving the second grating relatively to the first grating. While the second grating is moved relatively to the first grating with a scanning pitch that is obtained by equally dividing one period of a pitch of the second grating, the imaging is performed several times in correspondence to the number of divisions of one period, a change amount of the X-ray intensity modulation signal between the images captured several times is measured for each pixel of the X-ray image detector and a phase shift amount (which corresponds to a refraction angle of the X-ray) of a radiological image is calculated from the change amount of the intensity modulation signal, so that a phase contrast image is formed as the transmission image of the photographic subject.

Since the pitch of the second grating that is a driving target of the scanning is typically about several μm and the scanning pitch is about 1 μm, it is required that the scanning driving means should have a displacement resolution of sub micron or smaller. Accordingly, a piezoelectric actuator such as piezo device capable of performing fine feeding is appropriately used as the driving means. Also in JP-A-2008-200359 in which the first grating is relatively moved to the second grating, the piezoelectric actuator is used.

In the meantime, in JP-A-10-48531 and JP-A-2000-019415 in which regarding a general stage apparatus, rather than the X-ray imaging apparatus, a stage is driven by a piezoelectric actuator or ball screw, an elastic member such as spring or rubber member, which presses the stage in a direction opposite to the driving direction of the piezoelectric actuator or ball screw, is provided to apply preload, thereby enhancing the positioning accuracy.

Here, a refraction angle of the X-ray at the time of passing through the photographic subject is very small such as several grad and the phase shift amount of a radiological image corresponding to the refraction angle and the change amount of the intensity modulation signal of each pixel are also very small. When measuring the slight change amount, the grating vibration accompanied by the scanning highly influences the detection accuracy of the phase information. When the grating is vibrated in performing the scanning imaging, the determined scanning pitch is in disorder. Accordingly, the detection accuracy of the phase information based on the captured image is lowered. It may be preferable to perform the imaging until the grating vibration attenuates and converges, for each scanning pitch. However, when an interval from the imaging to the imaging is prolonged, the photographic subject is moved therebetween, so that the phase contrast is deteriorated and the phase detection accuracy is thus lowered. Therefore, the interval of the imaging time for each scanning pitch is preferably shorter and the total time necessary for the multiple imaging is required to be an order of seconds or shorter. Like this, it is important how to quickly attenuate the grating vibration accompanied by the scanning.

In the meantime, even when the pre-load is applied by using the elastic member, as disclosed in JP-A-10-48531 and JP-A-2000-019415, it is difficult to rapidly attenuate the vibration of the driving target. A vibration system by the elastic member is configured, so that the vibration convergence of the grating is delayed and the vibration may not be sufficiently attenuated for the short imaging time.

Considering the above problems, an object of the invention is to provide a radiographic apparatus and a radiographic system capable of rapidly attenuating vibration of a grating to improve detection accuracy of phase information and to shorten imaging time.

### SUMMARY OF INVENTION

[1] According to an aspect of the invention, a radiographic apparatus includes a first grating, a second grating, a scanning unit, and a radiological image detector. The second grating includes a periodic form that has a period which substantially coincides with a pattern period of a radiological image formed a radiation having passed through the first grating. The scanning unit relatively displaces the radiological image and the second grating to a plurality of relative positions at which phase differences between the radiological image and the second grating are different each other. The radiological image detector detects a masked radiological image which is formed by masking the radiological image by the second grating. The scanning unit includes a driving unit that drives at least one of the first grating and the second grating relatively to the other in a pattern arrangement direction of the radiological image and a plurality of elastic members that has natural frequencies different from each other and presses (urges) the driving target of the driving means in a direction opposite to a driving direction of the driving unit.

[2] A radiographic system includes the radiographic apparatus of [1] and a calculation processing unit that calculates, from an image detected by the radiological image detector of the radiographic apparatus, a distribution of refraction angles of the radiation incident onto the radiological image detector and generates a phase contrast image of a photographic subject based on the distribution of the refraction angles.

According to the radiological apparatus and the radiological system of the invention, when the driving target (at least one of the first and second gratings) is vibrated in association with the scanning, the vibrations of the elastic members urging the driving target are suppressed because the natural frequencies of the elastic members are different. Accordingly, it is possible to quickly attenuate the vibration of the driving target and the elastic members as a whole. That is, the elastic members having the different natural frequencies are used, so that it is possible to avoid configuring a vibration system by the elastic members and to realize a rapid convergence of the driving target while applying pre-load to the driving target. By rapidly attenuating the driving target, it is possible to improve the phase detection accuracy and to shorten the imaging time necessary for a plurality of imaging.

### BRIEF DESCRIPTION OF THE DRAWINGS

FIG. 1 is a side view pictorially showing a configuration of a radiographic system for illustrating an illustrative embodiment of the invention.

FIG. 2 is a control block diagram of the radiographic system of FIG. 1.

FIG. 3 is a pictorial view showing a configuration of a radiological image detector by using blocks.

FIG. 4 is a perspective view of first and second gratings and the radiological image detector.

FIG. 5 is a side view of the first and second gratings and the radiological image detector.

FIGS. 6A, 6B, and 6C are pictorial views showing a mechanism for changing a period of an interference fringe (moiré) resulting from an interaction of the first and second gratings.

FIG. 7 is a pictorial view for illustrating refraction of radiation by a photographic subject.

FIG. 8 is a pictorial view for illustrating a fringe scanning method.

FIG. 9 is a graph showing a pixel signal of the radiological image detector in accordance with the fringe scanning.

FIG. 10 is a pictorial view of the second grating and a scanning means.

FIG. 11 is a pictorial view of a second grating and a scanning means according to a first modified embodiment.

FIG. 12 is a pictorial view of a second grating and a scanning means according to a second modified embodiment.

FIG. 13 is a pictorial view of a second grating and a scanning means according to a third modified embodiment.

FIG. 14 is a pictorial view of a second grating and a scanning means according to a fourth modified embodiment.

FIG. 15 is a pictorial view of a second grating and a scanning means according to a fifth modified embodiment.

FIG. 16 is a pictorial view showing another example of a configuration of a radiographic system for illustrating an illustrative embodiment of the invention.

FIG. 17 is a pictorial view showing another example of a configuration of a radiographic system for illustrating an illustrative embodiment of the invention.

FIG. 18 is a perspective view of the radiographic system of FIG. 17.

FIG. 19 is a side view pictorially showing another example of a configuration of a radiographic system for illustrating an illustrative embodiment of the invention.

FIG. 20 is a side view pictorially showing another example of a configuration of a radiographic system for illustrating an illustrative embodiment of the invention.

FIG. 21 is a side view pictorially showing another example of a configuration of a radiographic system for illustrating an illustrative embodiment of the invention.

FIGS. 22A and 22B are side views pictorially showing another example of a configuration of a radiographic system for illustrating an illustrative embodiment of the invention.

FIG. 23 is a side view pictorially showing another example of a configuration of a radiographic system for illustrating an illustrative embodiment of the invention.

FIG. 24 is a block diagram showing a configuration of a calculation unit that generates a radiological image, in accordance with another example of a radiographic system for illustrating an illustrative embodiment of the invention.

FIG. 25 is a graph showing pixel signals of a radiological image detector for illustrating a process in the calculation unit of the radiographic system shown in FIG. 24.

### DETAILED DESCRIPTION

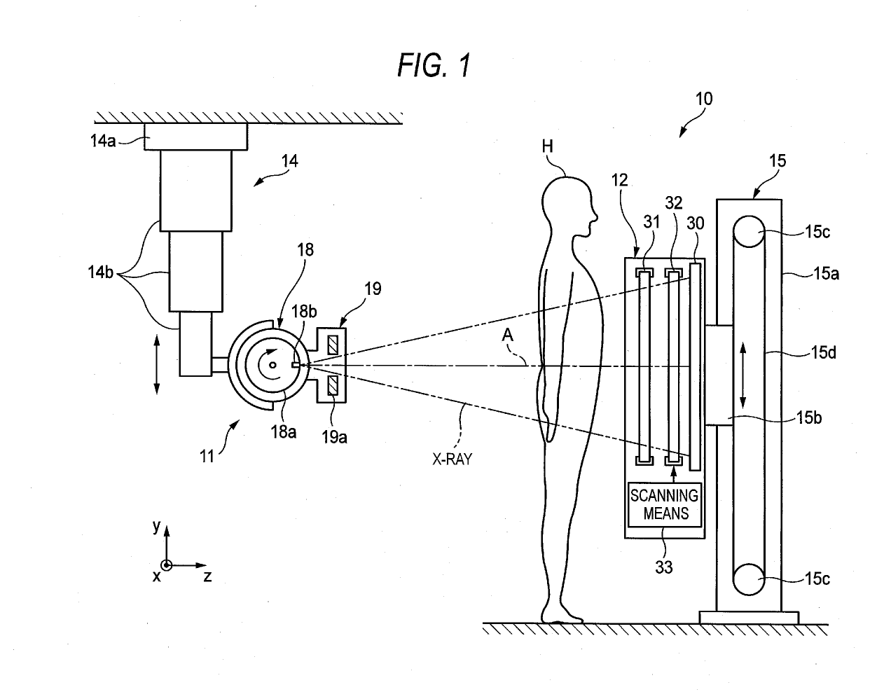

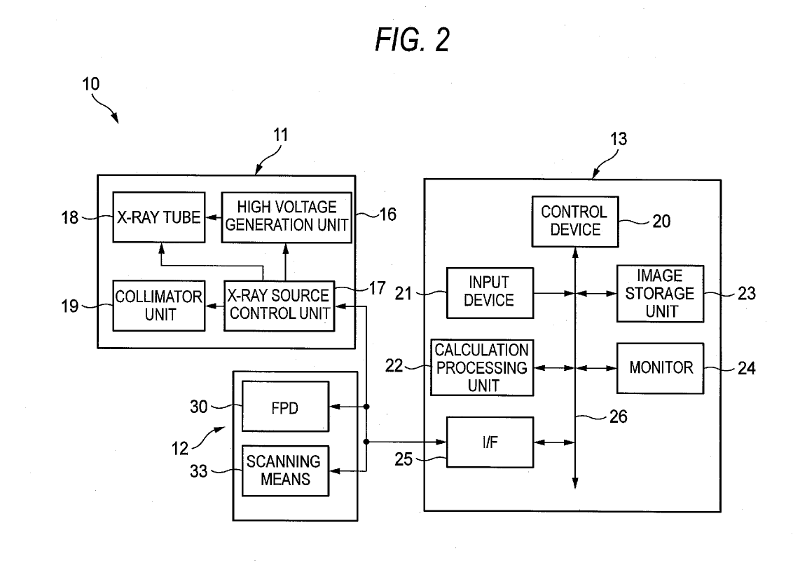

FIG. 1 shows an example of a configuration of a radiographic system for illustrating an illustrative embodiment of the invention and FIG. 2 is a control block diagram of the radiographic system of FIG. 1.

In the meantime, the same configurations as the configurations described already are indicated with the same reference numerals and the descriptions thereof are omitted. The differences with the configurations described already are described.

An X-ray imaging system 10 is an X-ray diagnosis apparatus that performs an imaging for a photographic subject (patient) H while the patient stands, and includes an X-ray source 11 that X-radiates the photographic subject H, a guide housing 16 that has a contact member contacting a diagnosis target part of the photographic subject H and supports the corresponding diagnosis target part, an imaging unit 12 that is opposed to the X-ray source 11 with the photographic subject H being interposed between the X-ray source 11 and the imaging unit, detects the X-ray having penetrated the photographic subject H from the X-ray source 11 and thus generates image data and a console 13 (refer to FIG. 2) that controls an exposing operation of the X-ray source 11 and an imaging operation of the imaging unit 12 based on an operation of an operator, calculates the image data acquired by the imaging unit 12 and thus generates a phase contrast image.

The X-ray source 11 is held so that it can be moved in an upper-lower direction (x direction) by an X-ray source holding device 14 hanging from the ceiling. The guide housing 16 is held that it can be moved in the upper-lower direction by an upright stand 15 mounted on the bottom.

The X-ray source 11 includes an X-ray tube 18 that generates the X-ray in correspondence to a high voltage applied to a high voltage generator 116, based on control of an X-ray source control unit 17 and a collimator unit 19 having a moveable collimator 19a that limits a radiation field so as to shield a part of the X-ray generated from the X-ray tube 18, which part does not contribute to an inspection area of the photographic subject H. The X-ray tube 18 is a rotary anode type X-ray tube that emits an electron beam from a filament (not shown) serving as an electron emission source (cathode) and collides the electron beam with a rotary anode 18a being rotating at predetermined speed, thereby generating the X-ray. A collision part of the electron beam of the rotary anode 18a is an X-ray focus 18b.

The X-ray source holding apparatus 14 includes a carriage unit 14a that is adapted to move in a horizontal direction (z direction) by a ceiling rail (not shown) mounted on the ceil and a plurality of strut units 14b that is connected in the upper-lower direction. The carriage unit 14a is provided with a motor (not shown) that expands and contracts the strut units 14b to change a position of the X-ray source 11 in the upper-lower direction.

The upright stand 15 includes a main body 15a that is mounted on the bottom and a holding unit 15b that holds the imaging unit 12 and is attached to the main body 15a so as to move in the upper-lower direction. The holding unit 15b is connected to an endless belt 15d that extends between two pulleys 16c spaced in the upper-lower direction, and is driven by a motor (not shown) that rotates the pulleys 15c. The driving of the motor is controlled by a control device 20 of the console 13 (which will be described later), based on a setting operation of the operator.

Also, the upright stand 15 is provided with a position sensor (not shown) such as potentiometer, which measures a moving amount of the pulleys 15c or endless belt 15d and thus detects a position of the imaging unit 12 in the upper-lower direction. The detected value of the position sensor is supplied to the X-ray source holding device 14 through a cable and the like. The X-ray source holding device 14 expands and contracts the struts 14b, based on the detected value, and moves the X-ray source 11 to follow the vertical moving of the imaging unit 12.

The console 13 is provided with the control device 20 that includes a CPU, a ROM, a RAM and the like. The control device 20 is connected with an input device 21 with which the operator inputs an imaging instruction and an instruction content thereof, a calculation processing unit 22 that calculates the image data acquired by the imaging unit 12 and thus generates an X-ray image, a storage unit 23 that stores the X-ray image, a monitor 24 that displays the X-ray image and the like and an interface (I/F) 25 that is connected to the respective units of the X-ray imaging system 10, via a bus 26.

As the input device 21, a switch, a touch panel, a mouse, a keyboard and the like may be used, for example. By operating the input device 21, radiography conditions such as X-ray tube voltage, X-ray radiation time and the like, an imaging timing and the like are input. The monitor 24 consists of a liquid crystal display and the like and displays letters such as radiography conditions and the X-ray image under control of the control device 20.

The imaging unit 12 has a flat panel detector (FPD) 30 that serves as a radiological image detector having a semiconductor circuit, and a first absorption type grating 31 and a second absorption type grating 32 that detect a phase change (angle change) of the X-ray by the photographic subject H and performs a phase imaging.

The imaging unit 12 is provided with a scanning mechanism 33 that translation-moves the second absorption type grating 32 in the upper-lower direction (x direction) and thus changes a relative position relation between the second absorption type grating 32 and the first absorption type grating 31. The FPD 30 has a detection surface that is arranged to be orthogonal to the optical axis A of the X-ray irradiated from the X-ray. As specifically described in the below, the first and second absorption type gratings 31, 32 are arranged between the FPD 30 and the X-ray source 11.

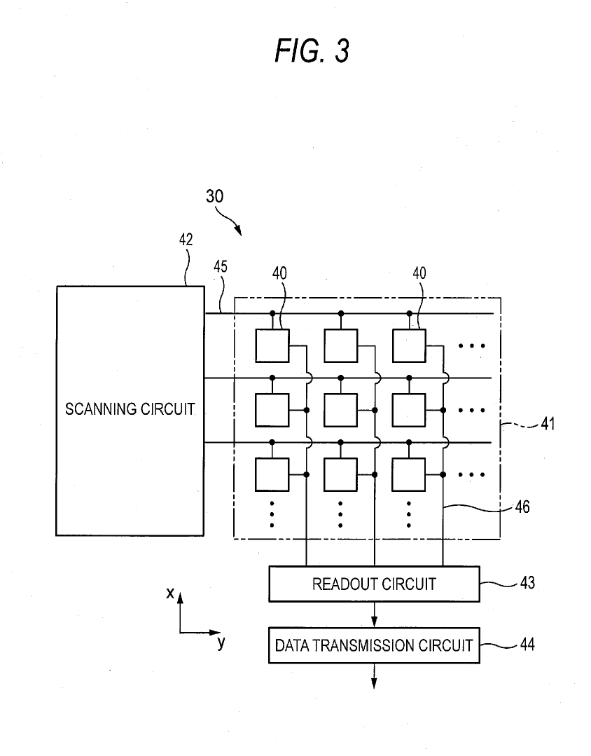

FIG. 3 shows a configuration of the radiological image detector that is included in the radiographic system of FIG. 1.

The FPD 30 serving as the radiological image detector includes an image receiving unit 41 having a plurality of pixels 40 that converts and accumulates the X-ray into charges and is two-dimensionally arranged in the xy directions on an active matrix substrate, a scanning circuit 42 that controls a timing of reading out the charges from the image receiving unit 41, a readout circuit 43 that reads out the charges accumulated in the respective pixels 40 and converts and stores the charges into image data and a data transmission circuit 44 that transmits the image data to the calculation processing unit 22 through the I/F 25 of the console 13. Also, the scanning circuit 42 and the respective pixels 40 are connected by scanning lines 45 in each of rows and the readout circuit 43 and the respective pixels 40 are connected by signal lines 46 in each of columns.

Each pixel 40, can be configured as a direct conversion type element that directly converts the X-ray with a conversion layer (not shown) made of amorphous selenium and the like and accumulates the converted charges in a capacitor (not shown) connected to a lower electrode of the conversion layer. Each pixel 40 is connected with a TFT switch (not shown) and a gate electrode of the TFT switch is connected to the scanning line 45, a source electrode is connected to the capacitor and a drain electrode is connected to the signal line 46. When the TFT switch turns on by a driving pulse from the scanning circuit 42, the charges accumulated in the capacitor are read out to the signal line 46.

In addition, each pixel 40 may be also configured as an indirect conversion type X-ray detection element that converts the X-ray into visible light with a scintillator (not shown) made of gadolinium oxide (Gd2O3), cesium iodide (CsI) and the like and then converts and accumulates the converted visible light into charges with a photodiode (not shown). Also, the X-ray image detector is not limited to the FPD based on the TFT panel. For example, a variety of X-ray image detectors based on a solid imaging device such as CCD sensor, CMOS sensor and the like may be also used.

The readout circuit 43 includes an integral amplification circuit, an A/D converter, a correction circuit and an image memory, which are not shown. The integral amplification circuit integrates and converts the charges output from the respective pixels 40 through the signal lines 46 into voltage signals (image signals) and inputs the same into the A/D converter. The A/D converter converts the input image signals into digital image data and inputs the same to the correction circuit. The correction circuit performs an offset correction, a gain correction and a linearity correction for the image data and stores the image data after the corrections in the image memory. Also, the correction process of the correction circuit may include a correction of an exposure amount and an exposure distribution (so-called shading) of the X-ray, a correction of a pattern noise (for example, a leak signal of the TFT switch) depending on control conditions (driving frequency, readout period and the like) of the FPD 30, and the like.

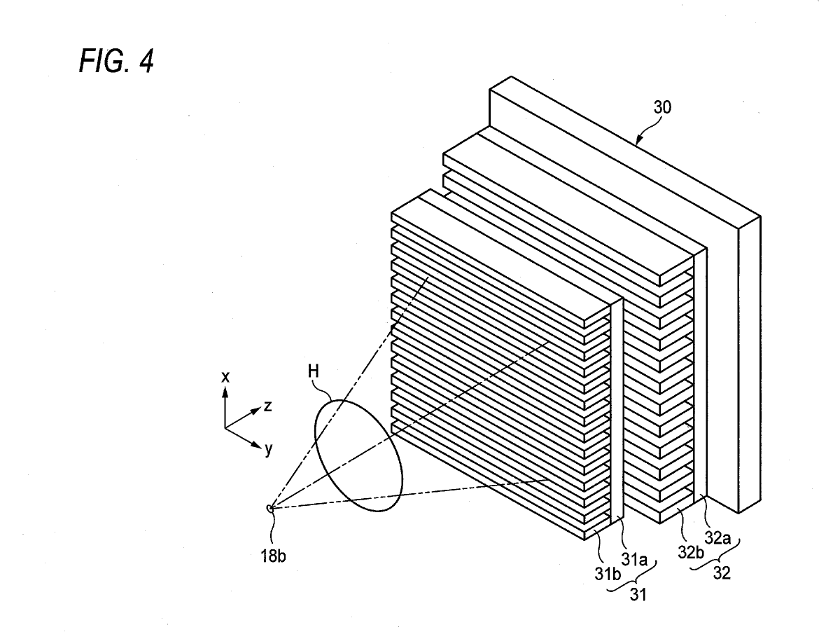

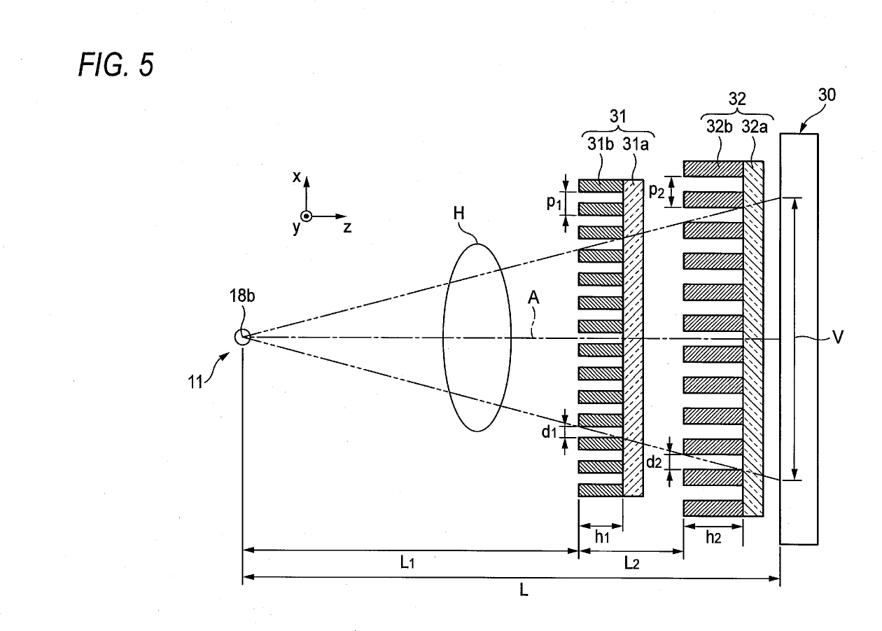

FIGS. 4 and 5 show the first and second gratings 31, 32 and the FPD 30.

The first absorption type grating 31 has a substrate 31a and a plurality of X-ray shield units 31b arranged on the substrate 31a. Likewise, the second absorption type grating 32 has a substrate 32a and a plurality of X-ray shield units 32b arranged on the substrate 32a. The substrates 31a, 32a are configured by radiolucent members through which the X-ray penetrates, such as glass.

The X-ray shield units 31b, 32b are configured by linear members extending in in-plane one direction (in the shown example, a y direction orthogonal to the x and z directions) orthogonal to the optical axis A of the X-ray irradiated from the X-ray source 11. As the materials of the respective X-ray shield units 31b, 32b, materials having excellent X-ray absorption ability are preferable. For example, the heavy metal such as gold, platinum and the like is preferable. The X-ray shield units 31b, 32b can be formed by the metal plating or deposition method.

The X-ray shield units 31b are arranged on the in-plane orthogonal to the optical axis A of the X-ray with a constant pitch p1 and at a predetermined interval d1 in the direction (x direction) orthogonal to the one direction. Likewise, the X-ray shield units 32b are arranged on the in-plane orthogonal to the optical axis A of the X-ray with a constant pitch p2 and at a predetermined interval d2 in the direction (x direction) orthogonal to the one direction.

Since the first and second absorption type gratings 31, 32 provide the incident X-ray with an intensity difference, rather than the phase difference, they are also referred to as amplitude type gratings. Also, the slit (area of the interval d1 or d2) may not be a void. For example, the void may be filled with X-ray low absorption material such as high molecule or light metal.

The first and second absorption type gratings 31, 32 are adapted to geometrically image the X-ray having passed through the slits, regardless of the Talbot interference effect. Specifically, the intervals d1, d2 are set to be sufficiently larger than a peak wavelength of the X-ray irradiated from the X-ray source 11, so that most of the X-ray included in the irradiated X-ray is enabled to pass through the slits while keeping the linearity, without being diffracted in the slits. For example, when the rotary anode 18a is made of tungsten and the tube voltage is 50 kV, the peak wavelength of the X-ray is about 0.4 Å. In this case, when the intervals d1, d2 are set to be about 1 to 10 μm, most of the X-ray is geometrically projected in the slits while the X-ray is not diffracted therein.

Since the X-ray irradiated from the X-ray source 11 is a conical beam having the X-ray focus 18b as an emitting point, rather than a parallel beam, a projection image (hereinafter, referred to as G1 image), which has passed through the first absorption type grating 31 and is projected, is enlarged in proportion to a distance from the X-ray focus 18b. The grating pitch p2 and the interval d2 of the second absorption type grating 32 are determined so that the slits substantially coincide with a periodic pattern of bright parts of the G1 image at the position of the second absorption type grating 32. That is, when a distance from the X-ray focus 18b to the first absorption type grating 31 is L1 and a distance from the first absorption type grating 31 to the second absorption type grating 32 is L2, the grating pitch p2 and the interval d2 are determined to satisfy following equations (1) and (2).

$$\begin{matrix}[ equation 1 ] & \\ {p}_{2} = \frac{{L}_{1} + {L}_{2}}{{L}_{1}} {p}_{1} & ( 1 ) \\ [ equation 2 ] & \\ {d}_{2} = \frac{{L}_{1} + {L}_{2}}{{L}_{1}} {d}_{1} & ( 2 )\end{matrix}$$

In the Talbot interferometer, the distance L2 from the first absorption type grating 31 to the second absorption type grating 32 is restrained with a Talbot interference distance that is determined by a grating pitch of a first diffraction grating and an X-ray wavelength. However, in the X-ray imaging system 10 of the invention, since the first absorption type grating 31 projects the incident X-ray without diffracting the same and the G1 image of the first absorption type grating 31 is similarly obtained at all positions of the rear of the first absorption type grating 31, it is possible to set the distance L2 irrespective of the Talbot interference distance.

Although the imaging unit 12 does not configure the Talbot interferometer, as described above, a Talbot interference distance Z that is obtained if the first absorption type grating 31 diffracts the X-ray is expressed by a following equation (3) using the grating pitch p1 of the first absorption type grating 31, the grating pitch p2 of the second absorption type grating 32, the X-ray wavelength (peak wavelength) and a positive integer m.

$$\begin{matrix}[ equation 3 ] & \\ Z = m \frac{{p}_{1} {p}_{2}}{λ} & ( 3 )\end{matrix}$$

The equation (3) indicates a Talbot interference distance when the X-ray irradiated from the X-ray source 11 is a conical beam and is known in “Atsushi Momose, et al., Japanese Journal of Applied Physics, Vol. 47, No. 10, 2008, August, page 8077).

In the X-ray imaging system (10), the distance L2 is set to be shorter than the minimum Talbot interference distance Z when m=1 so as to make the imaging unit 12 thin. That is, the distance L2 is set by a value within a range satisfying a following equation (4).

$$\begin{matrix}[ equation 4 ] & \\ {L}_{2} < \frac{{p}_{1} {p}_{2}}{λ} & ( 4 )\end{matrix}$$

In addition, when the X-ray irradiated from the X-ray source 11 can be considered as a substantially parallel beam, the Talbot interference distance Z is expressed by a following equation (5) and the distance L2 is set by a value within a range satisfying a following equation (6).

$$\begin{matrix}[ equation 5 ] & \\ Z = m \frac{{p}_{1}^{2}}{λ} & ( 5 ) \\ [ equation 6 ] & \\ {L}_{2} < \frac{{p}_{1}^{2}}{λ} & ( 6 )\end{matrix}$$

In order to generate a periodic pattern image having high contrast, it is preferable that the X-ray shield units 31b, 32b perfectly shield (absorb) the X-ray. Even when the materials (gold, platinum and the like) having excellent X-ray absorption ability are used, many X-ray penetrates the X-ray shield units. Accordingly, in order to improve the shield ability of X-ray, it is preferable to make thickness h1, h2 of the X-ray shield units 31b, 32b thicker as much as possible, respectively. For example, when the tube voltage of the X-ray tube 18 is 50 kV, it is preferable to shield 90% or more of the irradiated X-ray. In this case, the thickness h1, h2 are preferably 30 μm or larger, based on gold (Au).

In the meantime, when the thickness h1, h2 of the X-ray shield units 31b, 32b are excessively thickened, it is difficult for the obliquely incident X-ray to pass through the slits. Thereby, the so-called vignetting occurs, so that an effective field of view of the direction (x direction) orthogonal to the extending direction of the X-ray shield units 31b, 32b is narrowed. Therefore, from a standpoint of securing the field of view, the upper limits of the thickness h1, h2 are defined. In order to secure a length V of the effective field of view in the x direction on the detection surface of the FPD 30, when a distance from the X-ray focus 18b to the detection surface of the FPD 30 is L, the thickness h1, h2 are necessarily set to satisfy following equations (7) and (8), from a geometrical relation shown in FIG. 5.

$$\begin{matrix}[ equation 7 ] & \\ {h}_{1} \leq \frac{L}{V / 2} {d}_{1} & ( 7 ) \\ [ equation 8 ] & \\ {h}_{2} \leq \frac{L}{V / 2} {d}_{2} & ( 8 )\end{matrix}$$

For example, when d1=2.5 μm, d2=3.0 μm and L=2 m, assuming a typical diagnose in a hospital, the thickness h1 should be 100 μm or smaller and the thickness h2 should be 120 μm or smaller so as to secure a length of 10 cm as the length V of the effective field of view in the x direction.

In the imaging unit 12 configured as described above, an intensity-modulated image is formed by the superimposition of the G1 image of the first absorption type grating 31 and the second absorption type grating 32 and is captured by the FPD 30. A pattern period p1′ of the G1 image at the position of the second absorption type grating 32 and a substantial grating pitch p2′ of the second absorption type grating 32 (substantial pitch after the manufacturing) are slightly different due to the manufacturing error or arrangement error. The arrangement error means that the substantial pitches of the first and second absorption type gratings 31, 32 in the x direction are changed as the inclination, rotation and the interval therebetween are relatively changed.

Due to the slight difference between the pattern period p1′ of the G1 image and the grating pitch p2′, the image contrast becomes a moiré fringe. A period T of the moiré fringe is expressed by a following equation (9).

$$\begin{matrix}[ equation 9 ] & \\ T = \frac{p {1}^{′} \times p {2}^{′}}{\vert p {1}^{′} - p {2}^{′} \vert} & ( 9 )\end{matrix}$$

When it is intended to detect the moiré fringe with the FPD 30, an arrangement pitch P of the pixels 40 in the x direction should satisfy at least a following equation (10) and preferably satisfy a following equation (11) (n: positive integer).

[equation 10]

P≠nT (10)

[equation 11]

P<T (11)

The equation (10) means that the arrangement pitch P is not an integer multiple of the moiré period T. Even for a case of n≧2, it is possible to detect the moiré fringe in principle. The equation (11) means that the arrangement pitch P is set to be smaller than the moiré period T.

Since the arrangement pitch P of the pixels 40 of the FPD 30 are design-determined (in general, about 100 μm) and it is difficult to change the same, when it is intended to adjust a magnitude relation of the arrangement pitch P and the moiré period T, it is preferable to adjust the positions of the first and second absorption type gratings 31, 32 and to change at least one of the pattern period p1′ of the G1 image and the grating pitch p2′, thereby changing the moiré period T.

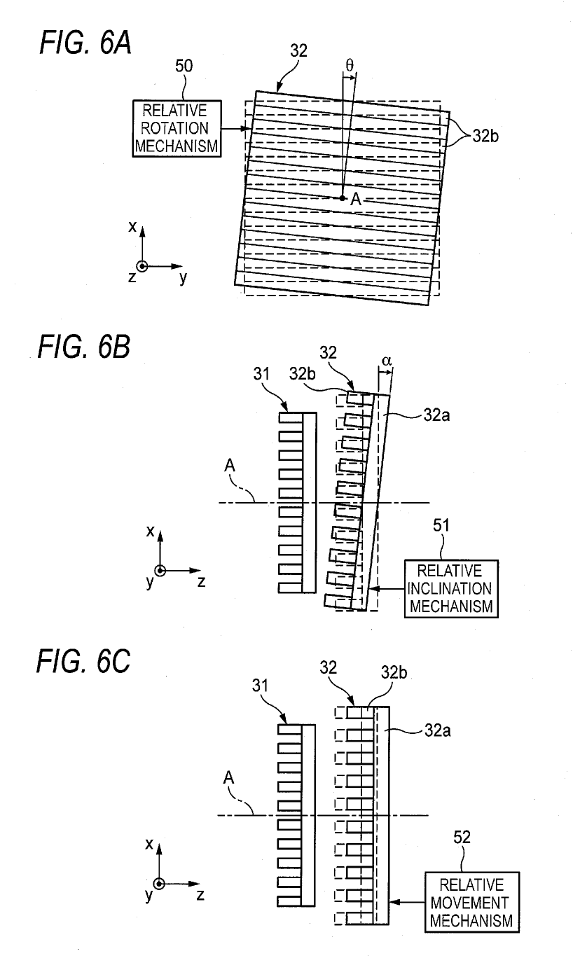

FIGS. 6A to 6C show a method of changing the moiré period T.

It is possible to change the moiré period T by relatively rotating one of the first and second absorption type gratings 31, 32 about the optical axis A. For example, there is provided a relative rotation mechanism 50 that rotates the second absorption type grating 32 relatively to the first absorption type grating 31 about the optical axis A. When the second absorption type grating 32 is rotated by an angle θ by the relative rotation mechanism 50, the substantial grating pitch in the x direction is changed from “p2′” to “p2′/cos θ”, so that the moiré period T is changed (refer to FIG. 6A).

As another example, it is possible to change the moiré period T by relatively inclining one of the first and second absorption type gratings 31, 32 about an axis orthogonal to the optical axis A and following the y direction. For example, there is provided a relative inclination mechanism 51 that inclines the second absorption type grating 32 relatively to the first absorption type grating 31 about an axis orthogonal to the optical axis A and following the y direction. When the second absorption type grating 32 is inclined by an angle α by the relative inclination mechanism 51, the substantial grating pitch in the x direction is changed from “p2′” to “p2′×cos θ”, so that the moiré period T is changed (refer to FIG. 6B).

As another example, it is possible to change the moiré period T by relatively moving one of the first and second absorption type gratings 31, 32 along a direction of the optical axis A. For example, there is provided a relative movement mechanism 52 that moves the second absorption type grating 32 relatively to the first absorption type grating 31 along a direction of the optical axis A so as to change the distance L2 between the first absorption type grating 31 and the second absorption type grating 32. When the second absorption type grating 32 is moved along the optical axis A by a movement amount δ by the relative movement mechanism 52, the pattern period of the G1 image of the first absorption type grating 31 projected at the position of the second absorption type grating 32 is changed from “p1′” to “p1′×(L1+L2+δ)/(L1+L2)”, so that the moiré period T is changed (refer to FIG. 6C).

In the X-ray imaging system 10, since the imaging unit 12 is not the Talbot interferometer and can freely set the distance L2, it can appropriately adopt the mechanism for changing the distance L2 and to thus change the moiré period T, such as the relative movement mechanism 52. The changing mechanisms (the relative rotation mechanism 50, the relative inclination mechanism 51 and the relative movement mechanism 52) of the first and second absorption type gratings 31, 32 for changing the moiré period T can be configured by actuators such as piezoelectric devices.

When the photographic subject H is arranged between the X-ray source 11 and the first absorption type grating 31, the moiré fringe that is detected by the FPD 30 is modulated by the photographic subject H. An amount of the modulation is proportional to the angle of the X-ray that is deviated by the refraction effect of the photographic subject H. Accordingly, it is possible to generate the phase contrast image of the photographic subject H by analyzing the moiré fringe detected by the FPD 30.

In the below, an analysis method of the moiré fringe is described.

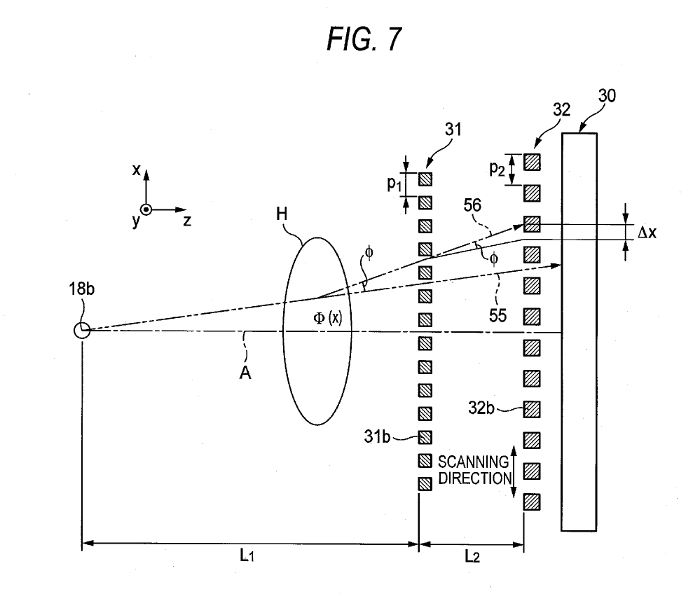

FIG. 7 shows one X-ray that is refracted in correspondence to a phase shift distribution Φ(x) in the x direction of the photographic subject H.

A reference numeral 55 indicates a path of the X-ray that goes straight when there is no photographic subject H. The X-ray traveling along the path 55 passes through the first and second absorption type gratings 31, 32 and is then incident onto the FPD 30. A reference numeral 56 indicates a path of the X-ray that is refracted and deviated by the photographic subject H. The X-ray traveling along the path 56 passes through the first absorption type grating 31 and is then shielded by the second absorption type grating 32.

The phase shift distribution Φ(x) of the photographic subject H is expressed by a following equation (12), when a refractive index distribution of the photographic subject H is indicated by n(x, z) and the traveling direction of the X-ray is indicated by z.

$$\begin{matrix}[ equation 12 ] & \\ Φ ( x ) = \frac{2 π}{λ} \int [ 1 - n ( x , z ) ] d z & ( 12 )\end{matrix}$$

The G1 image that is projected from the first absorption type grating 31 to the position of the second absorption type grating 32 is displaced in the x direction as an amount corresponding to a refraction angle φ, due to the refraction of the X-ray at the photographic subject H. An amount of displacement Δx is approximately expressed by a following equation (13), based on the fact that the refraction angle φ of the X-ray is slight.

[equation 13]

Δx≈L₂φ (13)

Here, the refraction angle γ is expressed by an equation (14) by using a wavelength λ of the X-ray and the phase shift distribution Φ(x) of the photographic subject H.

$$\begin{matrix}[ equation 14 ] & \\ ϕ = \frac{λ}{2 π} \frac{\partial Φ ( x )}{\partial x} & ( 14 )\end{matrix}$$

Like this, the amount of displacement Δx of the G1 image due to the refraction of the X-ray at the photographic subject H is related to the phase shift distribution Φ(x) of the photographic subject H. Also, the amount of displacement Δx is related to a phase difference amount ψ of a signal output from each pixel 40 of the FPD 40 (a difference amount of phase between a phase of a signal of each pixel 40 when there is the photographic subject H and a phase of a signal of each pixel 40 when there is no photographic subject H), as expressed by a following equation (15).

$$\begin{matrix}[ equation 15 ] & \\ ψ = \frac{2 π}{{p}_{2}} Δ x = \frac{2 π}{{p}_{2}} {L}_{2} ϕ & ( 15 )\end{matrix}$$

Therefore, when the phase difference amount ψ of a signal of each pixel 40 is calculated, the refraction angle φ is obtained from the equation (15) and a differential of the phase shift distribution Φ(x) is obtained by using the equation (14). Hence, by integrating the differential with respect to x, it is possible to generate the phase shift distribution Φ(x) of the photographic subject H, i.e., the phase contrast image of the photographic subject H. In the X-ray imaging system 10 of this illustrative embodiment, the phase difference amount ψ is calculated by using a fringe scanning method that is described below.

In the fringe scanning method, an imaging is performed while one of the first and second absorption type gratings 31, 32 is stepwise translation-moved relatively to the other in the x direction (that is, an imaging is performed while changing the phases of the grating periods of both gratings). In the X-ray imaging system 10 of this illustrative embodiment, the second absorption type grating 32 is moved by the scanning means 33. However, the first absorption type grating 31 may be moved. As the second absorption type grating 32 is moved, the moiré fringe is moved. When the translation distance (movement amount in the x direction) reaches one period (grating pitch p2) of the grating period of the second absorption type grating 32 (i.e., when the phase change reaches 2π), the moiré fringe returns to its original position. Regarding the change of the moiré fringe, while moving the second absorption type grating 32 by 1/n (n: integer) with respect to the grating pitch p2, the fringe images are captured in the FPD 30 and the signals of the respective pixels 40 are obtained from the captured fringe images and calculated in the calculation processing unit 22, so that the phase difference amount ψ of the signal of each pixel 40 is obtained.

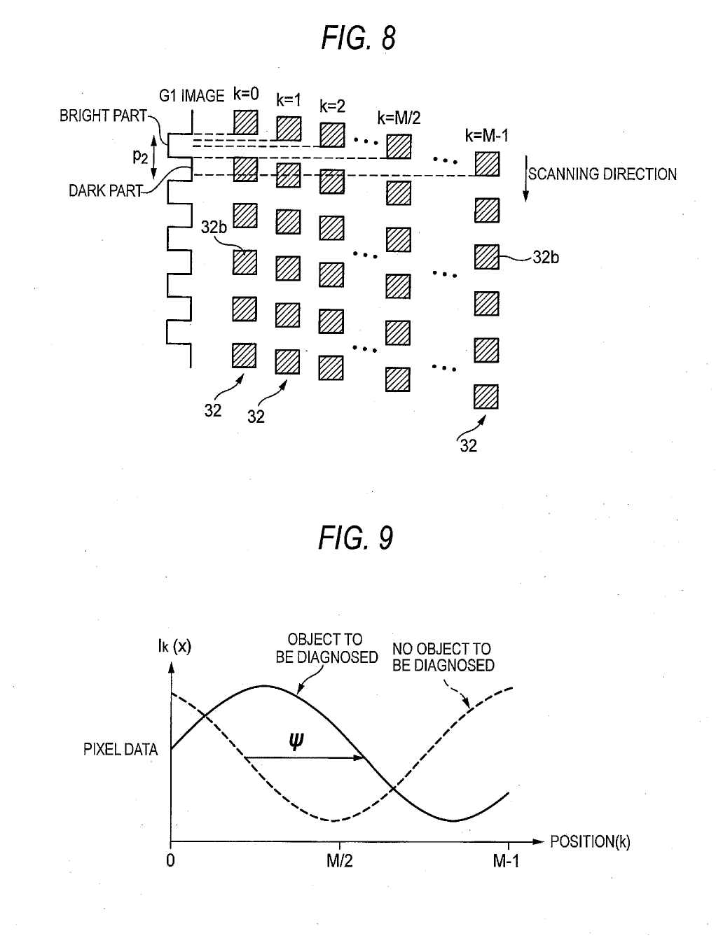

FIG. 8 pictorially shows that the second absorption type grating 32 is moved by a scanning pitch (p2/M) that is obtained by dividing the grating pitch p2 into M (M: integer of 2 or larger).

The scanning means 33 sequentially translation-moves the second absorption type grating 32 at each of M scanning positions of k=0, 1, 2, . . . , M−1. In FIG. 9, an initial position of the second absorption type grating 32 is a position (k=0) at which a dark part of the G1 image at the position of the second absorption type grating 32 when there is no photographic subject H substantially coincides with the X-ray shield unit 32b. However, the initial position may be any position of k=0, 1, 2, . . . , M−1.

First, at the position of k=0, mainly, the X-ray that is not refracted by the photographic subject H passes through the second absorption type grating 32. Then, when the second absorption type grating 32 is moved in order of k=1, 2, . . . , regarding the X-ray passing through the second absorption type grating 32, the component of the X-ray that is not refracted by the photographic subject H is decreased and the component of the X-ray that is refracted by the photographic subject H is increased. In particular, at the position of k=M/2, mainly, only the X-ray that is refracted by the photographic subject H passes through the second absorption type grating 32. At the position exceeding k=M/2, contrary to the above, regarding the X-ray passing through the second absorption type grating 32, the component of the X-ray that is refracted by the photographic subject H is decreased and the component of the X-ray that is not refracted by the photographic subject H is increased.

At each position of k=0, 1, 2, . . . , M−1, when the imaging is performed by the FPD 30, M signal values are obtained for the respective pixels 40. In the below, a method of calculating the phase difference amount ψ of the signal of each pixel 40 from the M signal values is described. When a signal value of each pixel 40 at the position k of the second absorption type grating 32 is indicated with Ik(x), Ik(x) is expressed by a following equation (16).

$$\begin{matrix}[ equation 16 ] & \\ {I}_{k} ( x ) = {A}_{0} + {\sum }_{n > 0} {A}_{n} exp [ 2 π i \frac{n}{{p}_{2}} \{ {L}_{2} ϕ ( x ) + \frac{{kp}_{2}}{M} \} ] & ( 16 )\end{matrix}$$

Here, x is a coordinate of the pixel 40 in the x direction, A0 is the intensity of the incident X-ray and An is a value corresponding to the contrast of the signal value of the pixel 40 (n is a positive integer). Also, φ(x) indicates the refraction angle φ as a function of the coordinate x of the pixel 40.

When a following equation (17) is used, the refraction angle φ(x) is expressed by a following equation (18).

$$\begin{matrix}[ equation 17 ] & \\ {\sum }_{k = 0}^{M - 1} exp ( - 2 π i \frac{k}{M} ) = 0 & ( 17 ) \\ [ equation 18 ] & \\ ϕ ( x ) = \frac{{p}_{2}}{2 π {L}_{2}} arg [ {\sum }_{K = 0}^{M - 1} {I}_{k} ( x ) exp ( - 2 π i \frac{k}{M} ) ] & ( 18 )\end{matrix}$$

Here, arg [ ] is a symbol of an operation which means the calculation of an argument. The calculated argument corresponds to the phase difference amount ψ of the signal in each pixel 40. Therefore, from the M signal values obtained from the respective pixels 40, the phase difference amount ψ of the signal of each pixel 40 is calculated based on the equation (18), and the refraction angle φ(x) is acquired.

FIG. 9 shows a signal of one pixel of the radiological image detector, which is changed depending on the fringe scanning.

The M signal values obtained from the respective pixels 40 are periodically changed with the period of the grating pitch p2 with respect to the position k of the second absorption type grating 32. The dotted line of FIG. 9 indicates the change of the signal value when there is no photographic subject H and the solid line of FIG. 9 indicates the change of the signal value when there is the photographic subject H. A phase difference of both waveforms corresponds to the phase difference amount ψ of the signal of each pixel 40.

Since the refraction angle φ(x) is a value corresponding to the differential phase value, as shown with the equation (14), the phase shift distribution Φ(x) is obtained by integrating the refraction angle φ(x) along the x axis.

The above calculations are performed by the calculation processing unit 22 and the calculation processing unit 22 stores the phase contrast image in the storage unit 23.

After the operator inputs the imaging instruction through the input device 21, the respective units operate in cooperation with each other under control of the control device 20, so that the fringe scanning and the generation process of the phase contrast image are automatically performed and the phase contrast image of the photographic subject H is finally displayed on the monitor 24.

Also, the X-ray is not mostly diffracted at the first absorption type grating 31 and is geometrically projected to the second absorption type grating 32. Accordingly, it is not necessary for the irradiated X-ray to have high spatial coherence and thus it is possible to use a general X-ray source that is used in the medical fields, as the X-ray source 11. In the meantime, since it is possible to arbitrarily set the distance L2 from the first absorption type grating 31 to the second absorption type grating 32 and to set the distance L2 to be smaller than the minimum Talbot interference distance of the Talbot interferometer, it is possible to miniaturize the imaging unit 12. Further, in the X-ray imaging system of this illustrative embodiment, since the substantially entire wavelength components of the irradiated X-ray contribute to the projection image (G1 image) from the first absorption type grating 31 and the contrast of the moiré fringe is improved, it is possible to improve the detection sensitivity of the phase contrast image.

FIG. 10 is a pictorial view of the second grating 32 and the scanning means 33.

The scanning means 33 includes a piezoelectric actuator 35 that serves as a driving means for driving the second grating 32 relatively to the first grating 31, compression coils springs 36, 36, 37, 37 that serve as a plurality of elastic members, a pair of guide rails 38, 38 that guides the second grating 32, which is a driving target, in the driving direction, and a voltage applying apparatus (not shown).

The piezoelectric actuator 35 includes a piezoelectric device, a reinforcement member of the piezoelectric device and the like, and is driven as displacement of the piezoelectric device, which is caused in applying a voltage, is transferred to the driving target. The piezoelectric actuator 35 is arranged at one end portion of the second grating 32 on a central line CL extending in the driving direction (+x direction) when the second grating 32 is bisected in the upper-lower direction, and is fixed to a support member 39 that is provided in the housing of the imaging unit 12. An operating point A at which the piezoelectric device of the piezoelectric actuator 35 is displaced in the x direction and applies the driving force to the second grating 32 is on the central line CL.

The four coil springs 36, 36, 37, 37 are provided between the support member 39 and an end portion of the second grating 32 at an opposite side to the side at which the piezoelectric actuator 35 of the second grating 32 is provided, so that they press the end portion of the second grating 32 in an opposite direction (−x direction) to the driving direction (+x direction). Thereby, since the piezoelectric actuator 35 is contacted to the second grating 32 with appropriate contact pressure (preload), it is possible to securely transfer the displacement of the piezoelectric device to the second grating 32. As a result, the second grating 32 is moved in good responsiveness to the displacement of the piezoelectric device.

In the meantime, since the second grating 32 is sandwiched at both sides in the driving direction by the piezoelectric actuator 35 and the compression coil springs 36, 36, 37, 37, the second grating is robust to the disturbance and can stably operate.

The coil springs 36, 36, 37, 37 consist of two types of springs having different natural frequencies, in which the two coil springs 36, 36 and the two coil springs 37, 37 have natural frequencies different from each other and the natural frequencies do not have a relation of an integer multiple each other. In the specification, the natural frequency means a fundamental frequency of natural vibration, i.e., first-order vibration of the natural vibration.

In the meantime, the natural frequencies of the coil springs 36, 37 are different from each other and are different from a frequency transferred by the power (here, natural frequency of the piezoelectric actuator) and do not have a relation of an integer multiple with the frequency transferred by the power. By the coil springs, it is possible to control the vibration of the grating that is the driving target. It is preferable that the natural frequencies of the coil springs 36, 37 are respectively lower than the frequency transferred by the power. In particular, it is preferable to set the natural frequencies of the coil springs to be ⅓ of the frequency transferred by the power, for example.

Here, the coil springs of the same type are symmetrically arranged about the central line CL. Specifically, the coil springs 36 are symmetrically arranged with the central line CL being interposed therebetween, and distances D1 from the respective springs 36 to the central line CL are equal. Likewise, the coil springs 37 are symmetrically arranged with the central line CL being interposed therebetween, and distances D2 from the respective springs 36 to the central line CL are equal.

In the meantime, the coil springs of the same type may be three. Also in this case, one coil spring is arranged on the central line CL, so that the other coil springs of the same type can be symmetrically arranged about the central line CL.

In addition to the two coil springs 36, 36 having a first natural frequency and the two coil springs 37 having a second natural frequency, a plurality of elastic members may be provided, including one coil spring having a third natural frequency. In this case, the coil spring having a third natural frequency may be arranged on the central line CL.

The guide rails 38, 38 are respectively fixed in the housing of the imaging unit 12 and hold both end portions of the second grating 32 in the y direction. By the guide rails 38, the second grating 32 is slid in the x direction with respect to the housing of the imaging unit 12.

As the fringe scanning method has been described above with reference to FIG. 8 and the like, the scanning means 33 stepwise moves the second grating 32 relatively to the first grating 31 with the scanning pitch (p2/M) that is obtained by equally dividing the pattern period (grating pitch p2) of the X-ray shield units 32b of the second grating 32.

Here, the integer M, which is the number of divisions of the grating pitch p2, is 3 or more integer, for example 5 (the number of imaging is five times), the amount of relative displacement between the G1 image by the scanning means 33 and the second grating 32, i.e., the scanning pitch (p2/5) corresponds to a section that is made by dividing the grating pitch p2 (pattern period) into 3 or more. At this time, by plotting the X-ray intensity at three points or more in one period of the grating pitch p2, it is possible to easily secure the graph showing the intensity change for each pixel, as shown in FIG. 9.

Like this, since the integer M, which is the number of divisions of the grating pitch p2, is 5, for example, and the pitch of the second grating 32 is typically several the scanning pitch (p2/5) is very small, such as about 1 μm. Therefore, it is necessary for the scanning means 35 to have a displacement resolution of sub micron or smaller. However, as described above, since the X-ray irradiated from the X-ray source 18 is the cone beam and the second grating 32 having the grating pitch p2 larger than the grating pitch p1 of the first grating 31 is moved relatively to the first grating 31, it is possible to easily keep the positioning accuracy high when relatively moving the first and second gratings 31, 32.

Also, for the integer M of 5, when the second grating 32 is moved relatively moved to the first grating 31 with the scanning pitch (p2/5), the G1 image and the second grating 32 are stepwise relatively displaced at five relative positions at which the phase differences between the fringe shape patterns of the G1 image and the second grating 32 are different, i.e., at the respective relative positions of the G1 image and the second grating 32 at which the phase differences are 0 (2π), 2π/5, 4π/5, 6π/5 and 8π/5.

At this time, when it is assumed that the total imaging time necessary for the five imaging is 1 second, a time period, which is allowed from the time at which the moiré image is captured at one relative position of the G1 image and the second grating 32 to the time at which the moiré image is captured at a next relative position, is 0.2 second.

When the piezoelectric device of the piezoelectric actuator 35 is applied with a voltage by the voltage applying apparatus (not shown), based on an instruction signal received from the control device 20 (refer to FIG. 2), the piezoelectric actuator 35 presses the second grating 32 in the +x direction (in the arrangement direction of the X-ray shield units 32b) with an amount of displacement corresponding to the applied voltage, so that the second grating 32 is moved relatively to the first grating 31. The second grating 32 is mainly vibrated in the x direction in association with the movement of the second grating 32 and the vibration is transferred to the coil springs 36, 36, 37, 37 that press the second grating 32.

Here, since the coil springs 36, 37 of the two types having the different natural frequencies, which do not have a relation of an integer multiple, are used, the vibrations of the coil springs 36, 36, 37, 37 are composed and suppressed each other. Accordingly, since a vibration system by the coil springs 36, 36, 37, 37 is not configured, the coil springs 36, 36, 37, 37 contribute to the control on the vibration of the second grating 32. Thereby, since the vibration attenuation of the second grating 32 is accelerated, the vibration of the second grating 32 is converged in short time of 0.2 second, for example.

Also, the coil springs 36, 36 and the coil springs 37, 37 of the two types having the different natural frequencies are symmetrically arranged about the central line CL passing to the operating point A, so that the spring forces are balanced at both sides of the central line CL and the moment is not thus generated in the z axis rotating direction. Accordingly, it is possible to stably transfer the displacement of the piezoelectric device to the second grating 92 without the inclination of the second grating 32. In addition, the relative rotation positions of the first and second gratings 31, 32 about the optical axis A following the z axis, which have been changed by the relative rotation mechanism 50 (refer to FIG. 6), are kept.

In the X-ray imaging by the fringe scanning method of using the first and second absorption type gratings 31, 32, the vibration highly influences the detection accuracy of the phase information when measuring the extremely slight change amount of the phase shift amount of the G1 image, the intensity modulation signal and the like. As described above, since the plurality of elastic members including the coil springs 36, 37 having the different natural frequencies is mounted to press the second grating 32 in the opposite direction to the driving direction, the vibration of the second grating 32 at the time of the scanning is quickly attenuated in short time.

In other words, since it is possible to perform the imaging with the vibration of the second grating 32 being sufficiently suppressed or converged, the scanning pitch (p2/5) is not in disorder and it is possible to obtain the not-blurred clear moiré image at the state in which the first and second gratings 31, 32 are positioned at the exact relative positions without being deviated in the arrangement direction of the X-ray shield units 31b, 32b. Since the contrast of the intensity change of the moiré image is not lowered in the plurality of captured images, it is possible to correctly perceive the change amount of the intensity modulation signal and to thus improve the phase detection accuracy.

Also, the time period in which the vibration of the second grating 32 is sufficiently attenuated is shortened, so that the photographic subject H is not moved well during the imaging. Thus, the phase contrast between the captured images is not lowered, so that the phase detection accuracy can be improved.

Since the imaging time interval at the respective relative positions of the G1 image and the second grating 32 can be shortened, it is possible to shorten the total imaging time necessary for the plurality of imaging.

Also, in the X-ray imaging system 10, the refraction angle φ is calculated by performing the fringe scanning for the projection image of the first grating. Thus, it has been described that the first and second gratings are the absorption type gratings. However, the invention is not limited thereto. As described above, the invention is useful even when the refraction angle φ is calculated by performing the fringe scanning for the Talbot interference image. Accordingly, the first grating is not limited to the absorption type grating and may be a phase type grating. Also, the analysis method of the moiré fringe that is formed by the superimposition of the X-ray image of the first grating and the second grating is not limited to the above fringe scanning method. For example, a variety of methods using the moiré fringe such as method of using Fourier transform/inverse Fourier transform known in “J. Opt. Soc. Am. Vol. 72, No. 1 (1982) p. 156” may be also applied.

Also, it has been described that the X-ray imaging system 10 stores or displays, as the phase contrast image, the image based on the phase shift distribution Φ. However, as described above, the phase shift distribution Φ is obtained by integrating the differential of the phase shift distribution Φ obtained from the refraction angle φ, and the refraction angle φ and the differential of the phase shift distribution Φ are also related to the phase change of the X-ray by the photographic subject. Accordingly, the image based on the refraction angle φ and the image based on the differential of the phase shift distribution Φ are also included in the phase contrast image.

In the above, the vibration of the second grating 32 resulting from the scanning of the second grating 32 has been described. In addition to this, however, the causes of the vibration may include the vibration that is transferred from the bottom on which the X-ray imaging system 10 is mounted, the vibration that is transferred from the X-ray source 11 depending on the apparatus mount circumstances, and the like. Even when the vibrations resulting from the causes are transferred to the second grating 32 and thus the second grating 32 is mainly vibrated in the x direction, it is possible to quickly attenuate the vibrations by the coil springs 36, 36, 37, 37, as described above. In the X-ray phase imaging by the fringe scanning method of using the first and second absorption type gratings 31, 32, from a standpoint of the phase detection accuracy, the vibration measure for correctly keeping the relative position of the first and second gratings 31, 32 and the respective relative positions of the X-ray focus 18a and the first and second gratings 31, 32 is particularly important. The fact that the any one of the vibration causes is removed by the coil springs 36, 36, 37, 37 has great significance.

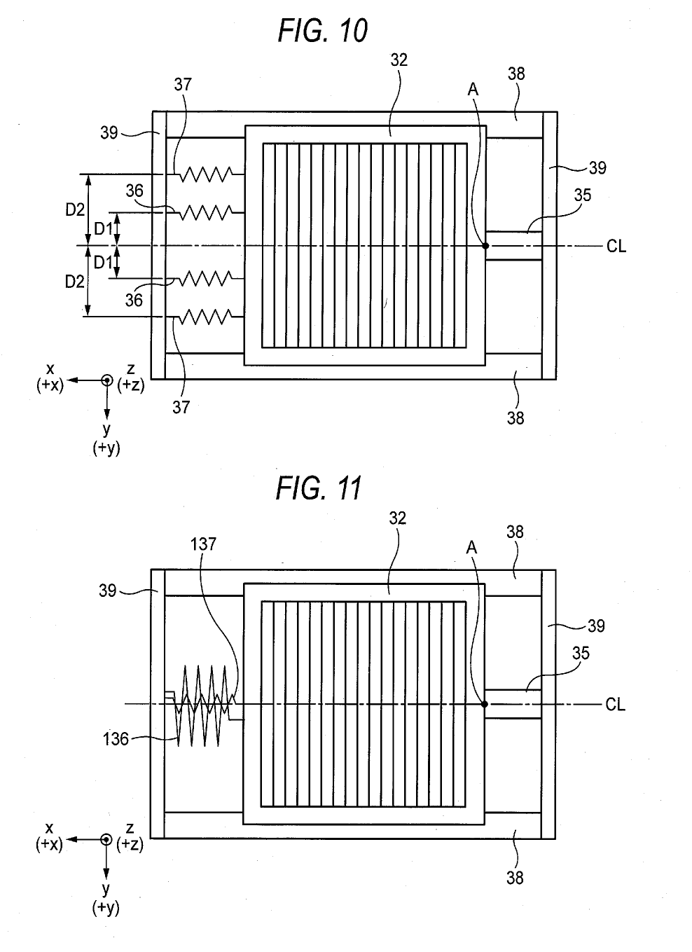

FIG. 11 shows a plurality of types of elastic members according to a first modified embodiment. The elastic members include a first coil spring 136 that is mounted on the central line CL passing to the operating point A of the piezoelectric actuator 35 and a second coil spring 137 that has a diameter smaller than that of the first coil spring 136 and is mounted at an inner side of the first coil spring 136. The respective natural frequencies of the first and second coil springs 136, 137 are different from each other and do not have a relation of an integer multiple. The first and second coil springs 136, 137 are coaxially mounted and the spring forces are balanced at both sides of the central line CL. Accordingly, it is possible to stably operate the second grating 32 without the inclination of the second grating 32.

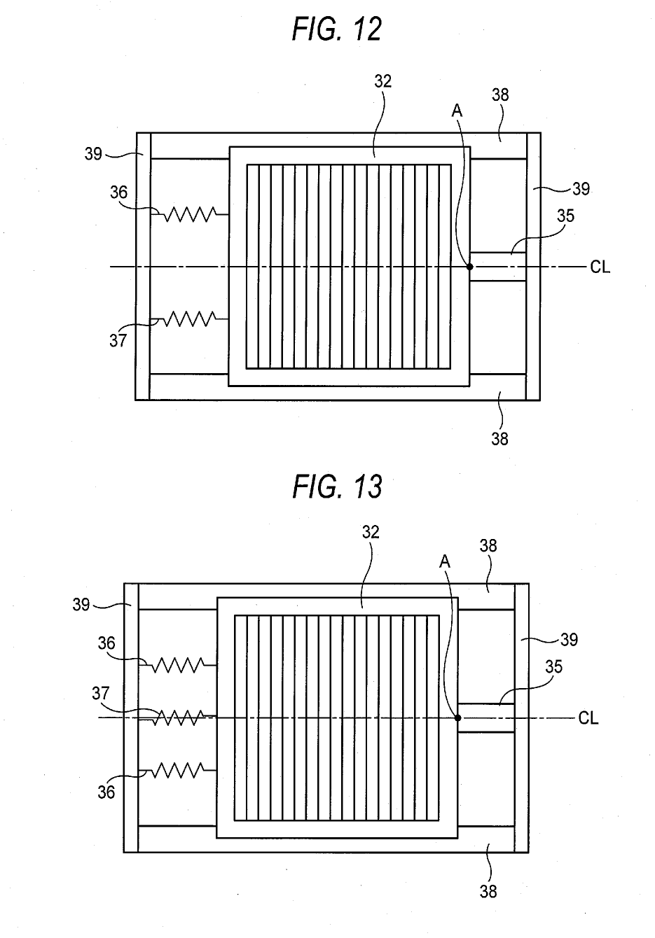

FIG. 12 shows a plurality of types of elastic members according to a second modified embodiment. The elastic members include two coil springs 36, 37 having different natural frequencies. The spring forces of the coil springs 36, 37 are different. However, the coil springs 36, 37 are symmetrically arranged about the central line CL, so that the spring forces are balanced at both sides of the central line CL. Accordingly, the inclination of the second spring 32 is suppressed.

In FIG. 12, the coil springs 36, 37 are symmetrically arranged, when seen from a plan view of the second grating 32. However, the coil springs 36, 37 may be symmetrically arranged at both sides of a central line in a thickness direction of the second grating 32 (which central line is a line extending in the driving direction when the second grating 32 is bisected in a thickness direction). In this case, the inclination of the second grating 32 in the thickness direction is suppressed.

FIG. 13 shows a plurality of types of elastic members according to a third modified embodiment. The elastic members include two coil springs 36, 36 having the same frequency and one coil spring 37 having a natural frequency different from that of the coil springs 36. The two coil springs 36 are symmetrically arranged at both sides of the central line CL and one coil spring 37 is arranged on the central line CL, so that the coil springs 36, 37 are symmetrically arranged for each type of the natural frequencies. By doing so, since the spring forces are balanced at both sides of the central line CL, it is possible to prevent the second grating 32 from being inclined.

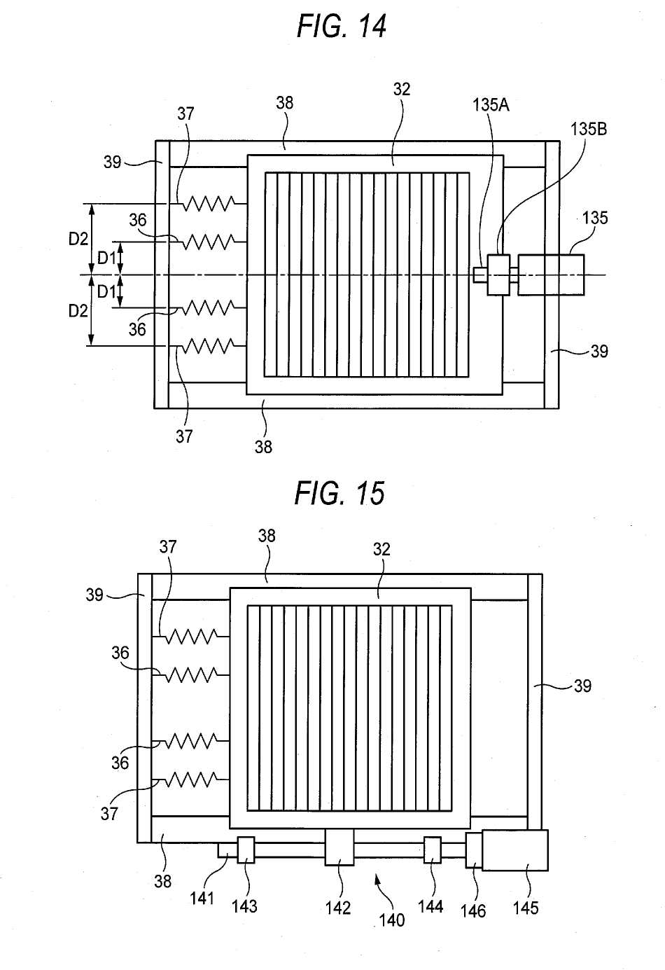

FIG. 14 shows a driving means according to a fourth modified embodiment. Instead of the piezoelectric actuator 35 of the above illustrative embodiment, a ball screw actuator 135 having a ball screw and a step motor integrated thereto may be provided as the driving means, as shown in FIG. 14. The ball screw actuator 135 includes a screw shaft 135A and a nut 135B fitted on the screw shaft 135A and the nut 135B is fixed to an end portion of the second grating 32. When the screw shaft 135A is rotated about the shaft by rotating force of the step motor, the nut 135B and the second grating 32 are moved in an axial direction of the screw shaft 135A by thrust force. Also in this configuration, it is possible to rapidly attenuate the vibration of the second grating 32 while narrowing the backlash of the ball screw and applying the preload by the coil springs 36, 36, 37, 37.

FIG. 15 shows a driving means according to a fifth modified embodiment. Here, the driving means includes a ball screw 140 and a step motor 145. The ball screw 140 includes a screw shaft 141, a nut 142 fitted on the screw shaft 141 and bearings 143, 144 supporting the screw shaft 141, and linearly drives the second grating 32 by rotating force of the step motor 145 that is provided to the screw shaft 141 via a coupling 146. Like the third embodiment, it is possible to rapidly attenuate the vibration of the second grating 32 while narrowing the backlash of the ball screw and applying the preload by the coil springs 36, 36, 37, 37.

In the meantime, when performing the scanning driving of relatively moving the first and second gratings 31, 32, the elastic members, which press the driving target (at least one of the first and second gratings 31, 32) in the opposite direction to the driving direction, are not limited to the compression coil springs. For example, a variety of elastic members such as the other springs, for example tension spring, plate spring and dish spring, rubber members, resin members and the like may be adopted. Also, the elastic members having different natural frequencies may be comprised of different materials such as spring, rubber member and resin member, respectively. For example, it may be considered that a coil spring is coaxially provided in a cylindrical rubber member.

In addition, it has been shown that the operating point A of the driving means such as piezoelectric actuator is arranged on the central line CL of the driving target (refer to FIGS. 10 and 11, for example). However, the invention is not limited thereto. For example, the operating point A may be provided at a position that is deviated from the central line CL.

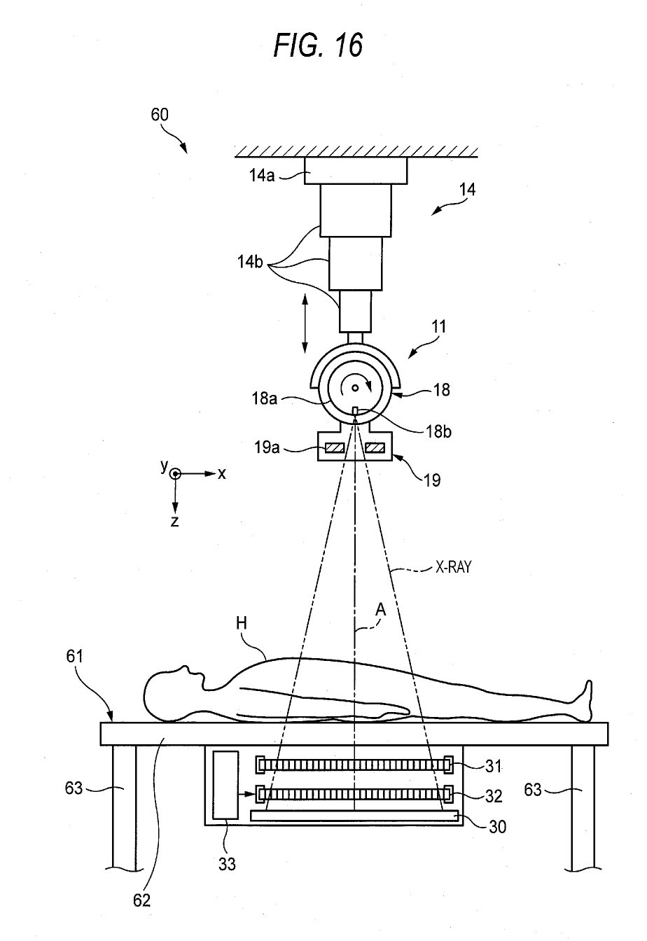

FIG. 16 shows another example of a configuration of a radiographic system for illustrating an illustrative embodiment of the invention.

An X-ray imaging system 60 is an X-ray diagnosis apparatus that performs an imaging while the photographic subject H (patient) lies down, and includes the X-ray source 11, the imaging unit 12 and a bed 61 on which the photographic subject H (patient) lies down. The configurations of the X-ray source 11, the first and second gratings 31, 32 of the imaging unit 10, the FPD 30 and the scanning means 33 are the same as the above configurations and the same reference numerals are thus used.

In this illustrative embodiment, the imaging unit 12 is attached on a lower surface of the top plate 62 so as to face the X-ray source 11 through the photographic subject H. The X-ray source 11 is held by the X-ray source holding device 14 and the X-ray irradiation direction faces downwards by an angle changing device (not shown) of the X-ray source 11. At this state, the X-ray source 11 irradiates the X-ray toward the photographic subject H that lies down on the top plate 62 of the bed 61. Since the X-ray source holding device 14 can vertically move the X-ray source 11 by the expansion and contraction of the struts 14b, it is possible to adjust a distance from the X-ray focus 18a to the detection surface of the PD 30 by the vertical movement.

As described above, since it is possible to shorten the distance L2 between the first absorption type grating 31 and the second absorption type grating 32 and to thus miniaturize the imaging unit 12, it is possible to shorten legs 63 supporting the top plate 62 of the bed 61 and to thus lower the position of the top plate 62. For example, it is preferable to miniaturize the imaging unit 12 and to lower the position of the top plate 62 to a height (for instance, about 40 cm from the bottom) at which the photographic subject H (patient) can easily sit. Also, the lowering of the position of the top plate 62 is preferable when securing the sufficient distance from the X-ray source 11 to the imaging unit 12.

In addition, contrary to the position relation between the X-ray source 11 and the imaging unit 12, it may be possible to perform the imaging while the photographic subject H lies down, by attaching the X-ray source 11 to the bed 61 and mounting the imaging unit 12 on the ceiling.

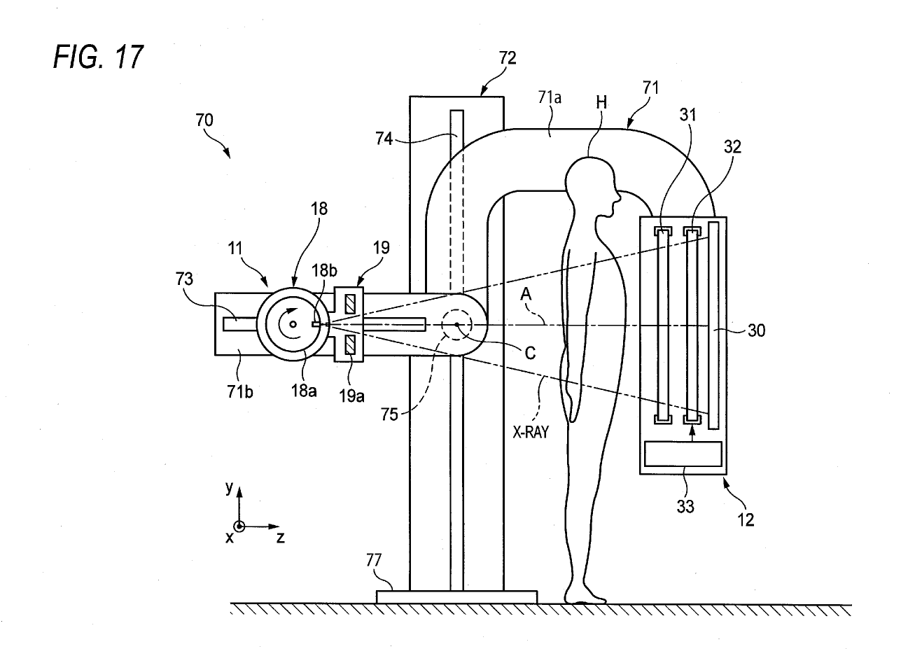

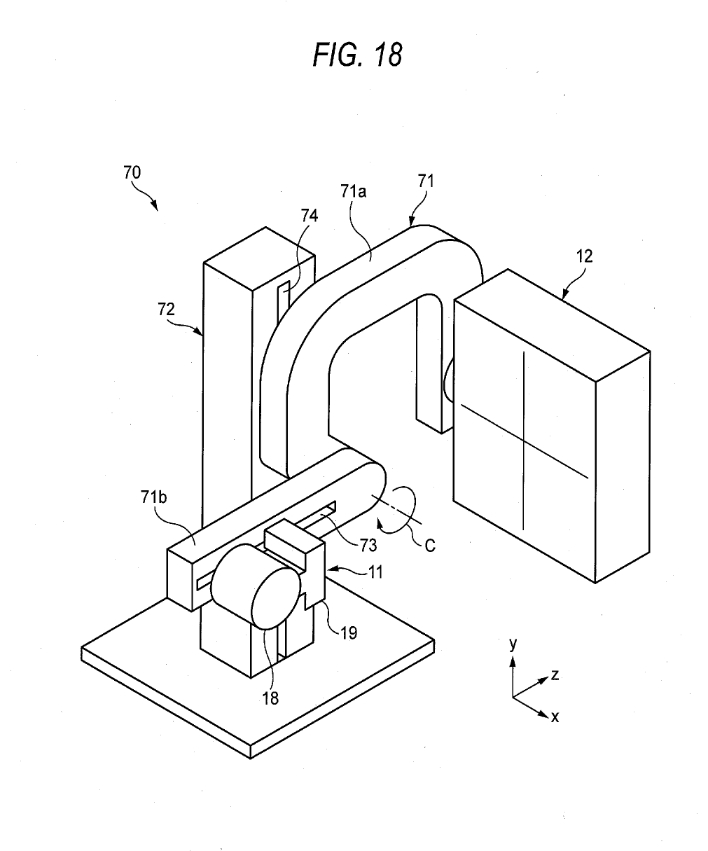

FIGS. 17 and 18 show another example of the X-ray imaging system for illustrating an illustrative embodiment of the invention. The X-ray imaging system 70 is an X-ray diagnosis apparatus that performs an imaging while the photographic subject H stands and lies down.

The X-ray source 11 and the imaging unit 12 are held by a rotational arm 71. The rotational arm 71 is rotatably connected to a base platform 72.

The rotational arm 71 has a U-shaped part 71a having a substantially U shape and a linear part 71b that is connected to one end of the U-shaped part 71a. The other end of the U-shaped part 71a is mounted with the imaging unit 12. The linear part 71b is formed with a first recess 73 along the extending direction thereof. The X-ray source 11 is slidably mounted in the first recess 73. The X-ray source 11 and the imaging unit 12 are opposed to each other. By moving the X-ray source 11 along the first recess 73, it is possible to adjust the distance from the X-ray focus 18b to the detection surface of the FPD 30.

Also, the base platform 72 is formed with a second recess 74 extending in the upper-lower direction. The rotational arm 71 is adapted to vertically move along the second recess 74 by a connection mechanism 75 that is connected to the U-shaped part 71a and the linear part 71b. Also, the rotational arm 71 is adapted to rotate about a rotational axis C following the y direction by the connection mechanism 75. When the rotational arm 71 is 90°-rotated clockwise about the rotational axis C from the standing posture imaging state shown in FIG. 17 and the imaging unit 12 is arranged below a bed (not shown) on which the photographic subject H lies down, it is possible to perform the lying down posture imaging. In the meantime, the rotational arm 71 is not limited to the 90° rotation and can be rotated by a predetermined angle. Also, it is possible to perform the imaging in any direction, in addition to the standing posture imaging (horizontal direction) and the lying down posture imaging (vertical direction).

In this illustrative embodiment, the X-ray source 11 and the imaging unit 12 are held by the rotational arm 71. Therefore, compared to the above embodiments, it is possible to set the distance from the X-ray source 11 to the imaging unit 12 easily and accurately.

In this illustrative embodiment, the imaging unit 12 is provided to the U-shaped part 71a and the X-ray source 11 is provided to the linear part 71b. However, like an X-ray diagnosis apparatus using a so-called C arm, the imaging unit 12 may be provided to one end of the C arm and the X-ray source 11 may be provided to the other end of the C arm.

In the below, an illustrative embodiment is described in which the invention is applied to a mammography (X-ray breast imaging). A mammography apparatus 80 shown in FIG. 13 is an apparatus of capturing an X-ray image (phase contrast image) of a breast B that is the photographic subject. The mammography apparatus 80 includes an X-ray source accommodation unit 82 that is mounted to one end of an arm member 81 rotatably connected to a base platform (not shown), an imaging platform 83 that serves as the guide housing and is mounted to the other end of the arm member 81 and a compression plate 84 that is configured to vertically move relatively to the imaging platform 83.

The X-ray source 11 is accommodated in the X-ray source accommodation unit 82 and the imaging unit 12 is accommodated in the imaging platform 83. The X-ray source 11 and the imaging unit 12 are arranged to face each other. The compression plate 84 is moved by a moving mechanism (not shown) and presses the breast B between the compression plate and the imaging platform 83. At this pressing state, the X-ray imaging is performed.

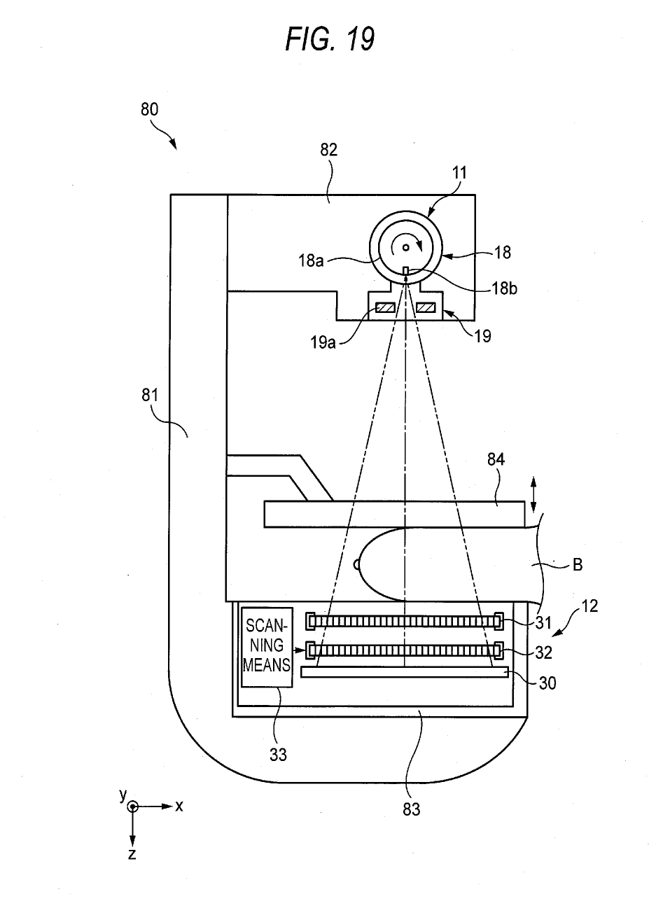

The grating unit housing 35 shown in FIG. 19 is supported to the imaging platform 83 via the buffer materials 36, 37, like the configuration shown in FIG. 16. Thereby, the same effects as the above are obtained.

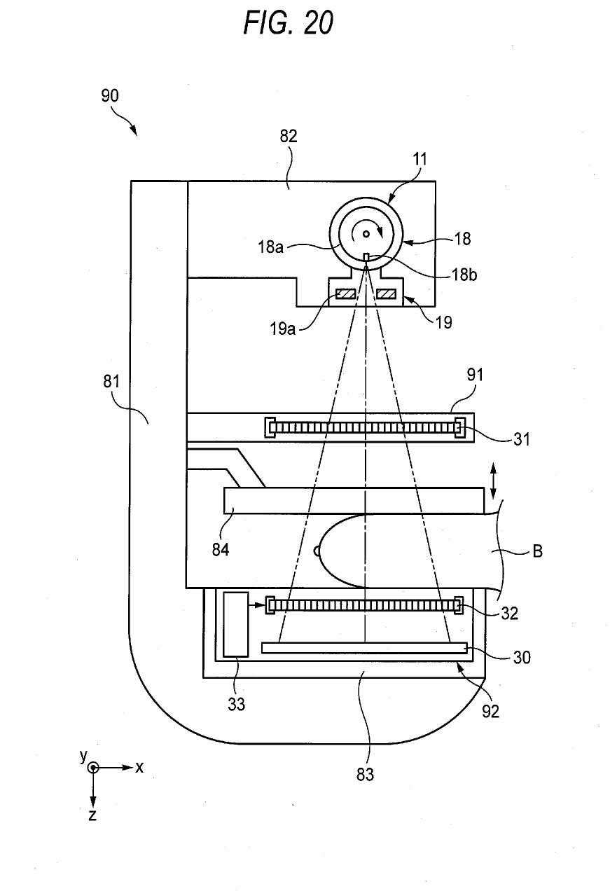

In the below, a modified embodiment of the mammography apparatus is described. A mammography apparatus 90 shown in FIG. 20 is different from the mammography apparatus 80 in that the first absorption type grating 31 is provided between the X-ray source 11 and the compression plate 84. The first absorption type grating 31 is accommodated in a grating accommodation unit 91 that is connected to the arm member 81. An imaging unit 92 does not have the first absorption type grating 31 and is configured by the FPD 30, the second absorption type grating 32 and the scanning means 33.

Like this, even when the object to be diagnosed (breast) B is positioned between the first absorption type grating 31 and the second absorption type grating 32, the projection image (G1 image) of the first absorption type grating 31, which is formed at the position of the second absorption type grating 32, is deformed by the object to be diagnosed B. Accordingly, also in this case, it is possible to detect the moiré fringe, which is modulated due to the object to be diagnosed B, by the FPD 30. That is, also in this illustrative embodiment, it is possible to obtain the phase contrast image of the object to be diagnosed B by the above-described principle.

In this illustrative embodiment, since the X-ray whose radiation dose has been substantially halved by the shielding of the first absorption type grating 31 is irradiated to the object to be diagnosed B, it is possible to decrease the radiation exposure amount of the object to be diagnosed B about by half, compared to the above illustrative embodiments. In the meantime, the configuration in which the object to be diagnosed is arranged between the first absorption type grating 31 and the second absorption type grating 32 is not limited to the mammography apparatus of this illustrative embodiment and can be applied to the other X-ray imaging systems.

FIG. 14 shows another example of the radiographic system for illustrating an illustrative embodiment of the invention. A radiographic system 100 is different from the radiographic system 10 in that a multi-slit 103 is provided to a collimator unit 102 of an X-ray source 101.

In the above illustrative embodiment, when the distance from the X-ray source 11 to the FPD 30 is set to be same as a distance (1 to 2 m) that is set in an imaging room of a typical hospital, the blurring of the G1 image may be influenced by a focus size (in general, about 0.1 mm to 1 mm) of the X-ray focus 18b, so that the quality of the phase contrast image may be deteriorated. Accordingly, it may be considered that a pin hole is provided just after the X-ray focus 18b to effectively reduce the focus size. However, when an opening area of the pin hole is decreased so as to reduce the effective focus size, the X-ray intensity is lowered. In this illustrative embodiment, in order to solve this problem, the multi-slit 103 is arranged just after the X-ray focus 18b.

The multi-slit 103 is an absorption type grating (i.e., third absorption grating) having the same configuration as the first and second absorption type gratings 31, 32 provided to the imaging unit 12 and has a plurality of X-ray shield units extending in one direction (y direction, in this illustrative embodiment), which are periodically arranged in the same direction (x direction, in this illustrative embodiment) as the X-ray shield units 31b, 32b of the first and second absorption type gratings 31, 32. The multi-slit 103 is to partially shield the radiation from the X-ray source 11, thereby reducing the effective focus size in the x direction and forming a plurality of point light sources (disperse light sources) in the x direction.

It is necessary to set a grating pitch p3 of the multi-slit 103 so that it satisfies a following equation (19), when a distance from the multi-slit 103 to the first absorption type grating 31 is L3.

$$\begin{matrix}[ equation 19 ] & \\ {p}_{3} = \frac{{L}_{3}}{{L}_{2}} {p}_{2} & ( 19 )\end{matrix}$$

Also, in this illustrative embodiment, since the position of the multi-slit 103 is substantially the X-ray focus position, the grating pitch p2 and the interval d2 of the second absorption type grating 32 are determined to satisfy following equations (20) and (21).

$$\begin{matrix}[ equation 20 ] & \\ {p}_{2} = \frac{{L}_{3} + {L}_{2}}{{L}_{3}} {p}_{1} & ( 20 ) \\ [ equation 21 ] & \\ {d}_{2} = \frac{{L}_{3} + {L}_{2}}{{L}_{3}} {d}_{1} & ( 21 )\end{matrix}$$

Also, in this illustrative embodiment, when it is intended to secure a length V of the effective field of view in the x direction on the detection surface of the FPD 30, the thickness h1, h2 of the X-ray shield units 31b, 32b of the first and second absorption type gratings 31, 32 are determined to satisfy following equations (22) and (23) when a distance from the multi-slit 103 to the detection surface of the FPD 30 is L′.

$$\begin{matrix}[ equation 22 ] & \\ {h}_{1} \leq \frac{{L}^{′}}{V / 2} {d}_{1} & ( 22 ) \\ [ equation 23 ] & \\ {h}_{2} \leq \frac{{L}^{′}}{V / 2} {d}_{2} & ( 23 )\end{matrix}$$

The equation (19) is a geometrical condition so that the projection image (G1 image) of the X-ray, which is emitted from the respective point light sources dispersedly formed by the multi-slit 103, by the first absorption type grating 31 coincides (overlaps) at the position of the second absorption type grating 32. Like this, in this illustrative embodiment, the G1 image based on the point light sources formed by the multi-slit 103 overlaps, so that it is possible to improve the quality of the phase contrast image without lowering the X-ray intensity.

Also, the multi-slit 103 can be applied to any of the above illustrative embodiments.

In addition, in the above p1 illustrative embodiments, as described above, the phase contrast image is based on the refracted components of the X-ray in the periodic arrangement direction (x direction) of the X-ray shield units 31b, 32b of the first and second absorption type p1 gratings 31, 32, and the refracted components in the extending direction (y direction) of the X-ray shield units 31b, 32b are not reflected thereto. In other words, a part outline along the direction (when running at right angle, y direction) intersecting with the x direction is represented, as the phase contrast image based on the refracted components of the x direction, through the grating surface that is the xy plane, and a part outline following the x direction without intersecting with the x direction is not represented as the phase contrast image of the x direction. That is, there is a part that cannot be represented depending on the shape and direction of the part to be the photographic subject H. For example, when a direction of a load surface of the articular cartilage of a knee is made to match the y direction of the xy directions that are the in-plane directions, a part outline adjacent to the load surface (yz plane) following the y direction is sufficiently represented but the tissue (for example, tendon, ligament and the like) around the cartilage, which intersects with the load surface and extends along the x direction, is not sufficiently represented. By moving the photographic subject H, it is possible to capture the insufficiently represented part again. However, the burdens of the photographic subject H and the operator are increased and it is difficult to secure the position reproducibility with the re-captured image.

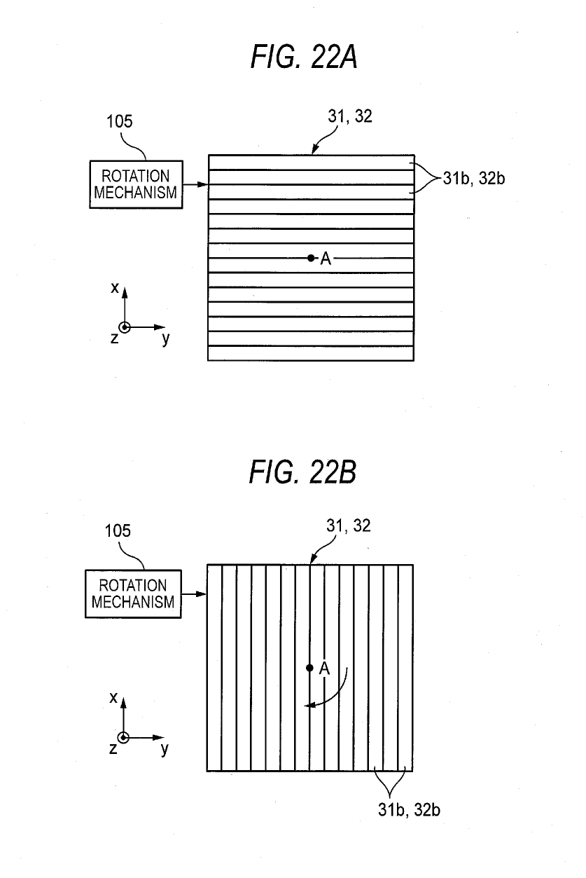

Accordingly, as another example, as shown in FIGS. 22A and 22B, it may be possible that a rotation mechanism 105, which integrally rotates the first and second absorption type gratings 31, 32 by an arbitrary angle from a first direction along the x axis as shown in FIG. 22A to a second direction along the y axis as shown in FIG. 22B about an imaginary line (the optical axis A of the X-ray) orthogonal to centers of the grating surfaces of the first and second absorption type gratings 31, 32, is provided and the phase contrast images are respectively generated at each of the first and second directions. By doing so, it is possible to solve the above problem of the position reproducibility. Also, in FIG. 22A, the first direction of the first and second gratings 31, 32 is shown in which the extending direction of the X-ray shield units 31b, 32b follows the y direction, and in FIG. 22B, the second direction of the first and second gratings 31, 32 is shown in which the state of FIG. 22A is rotated by 90 degrees and thus the extending direction of the X-ray shield units 31b, 32b follows the x direction. At this time, the rotating angle of the first and second gratings is arbitrary. In addition to the first and second directions, two or more rotation operations such as third and fourth directions may be performed and the phase contrast images may be generated at the respective directions.

Also, the rotation mechanism 105 may integrally rotate only the first and second absorption type gratings 31, 32 separately from the FPD 30 or integrally rotate the FPD 30 together with the first and second absorption type gratings 31, 32. Furthermore, the generation of the phase contrast images at the first and second directions by using the rotation mechanism 105 can be applied to any of the above illustrative embodiments.

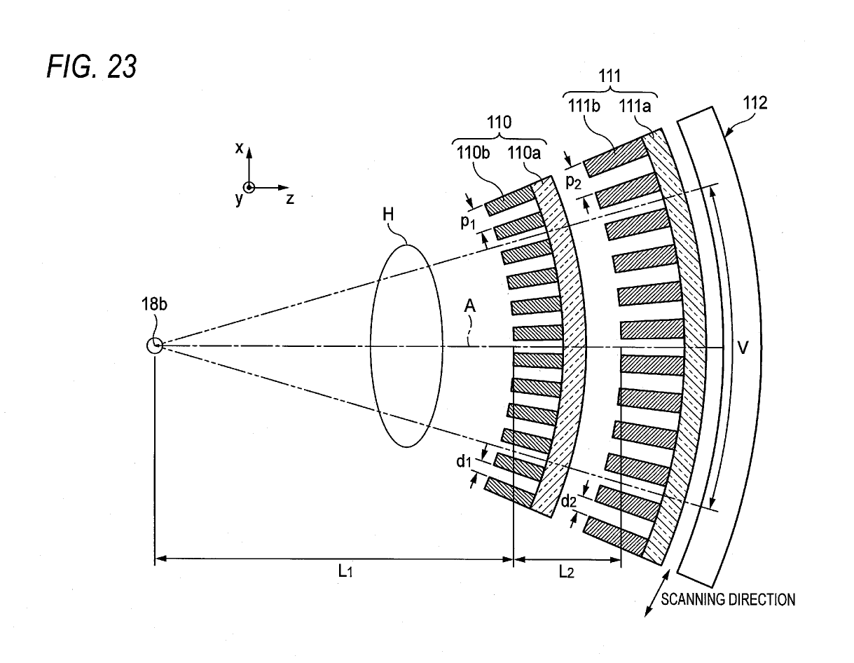

Also, the first and second absorption type gratings 31, 32 are configured so that the periodic arrangement direction of the X-ray shield units 31b, 32b is linear (i.e., the grating surfaces are planar). However, instead of this, first and second absorption type gratings 110, 111 having grating surfaces that are concave on a curved surface may be used, as shown in FIG. 23.

The first absorption type grating 110 has a plurality of X-ray shield units 110b, which are periodically arranged with a predetermined pitch p1 on a surface of a radiolucent and curved substrate 110a. Each of the X-ray shield units 110b linearly extends in the y direction, like the above illustrative embodiments, and a grating surface of the first absorption type grating 110 has a cylindrical shape having a central axis that is a line passing to the X-ray focus 18b and extending in the extending direction of the X-ray shield units 110b. Likewise, the second absorption type grating 111 has a plurality of X-ray shield units 111b, which are periodically arranged with a predetermined pitch p2 on a surface of a radiolucency and curved substrate 111a. Each of the X-ray shield units 111b linearly extends in the y direction, and a grating surface of the second absorption type grating 111 has a cylindrical shape having a central axis that is a line passing to the X-ray focus 18b and extending in the extending direction of the X-ray shield units 111b.

When a distance from the X-ray focus 18b to the first absorption type grating 110 is L1 and a distance from the first absorption type grating 110 to the second absorption type grating 111 is L2, the grating pitch p2 and the interval d2 are determined to satisfy the equation (1). The opening width d1 of the slit of the first absorption type grating 110 and the opening width d2 of the slit of the second absorption type grating 111 are determined to satisfy the equation (2).

Like this, the grating surfaces of the first and second absorption type gratings 110, 111 are made to be the cylindrical surfaces, so that the X-ray irradiated from the X-ray focus 18b is perpendicularly incident onto the grating surfaces when there is no photographic subject H. Therefore, in this illustrative embodiment, the restraint on the upper limits of the thickness h1 of the X-ray shield unit 110b and the thickness h2 of the X-ray shield unit 111b is relaxed, so that it is not necessary to consider the equations (7) and (8).

Also, in this illustrative embodiment, one of the first and second absorption type gratings 110, 111 is moved in a direction following the grating surface (cylindrical surface) about the X-ray focus 18b, so that the above fringe scanning is performed. Furthermore, in this illustrative embodiment, it is preferable to use an FPD 112 having a detection surface that is a cylindrical surface. Likewise, the detection surface of the FPD 112 is a cylindrical surface having a central axis that is a line passing to the X-ray focus 18b and extending in the y direction.

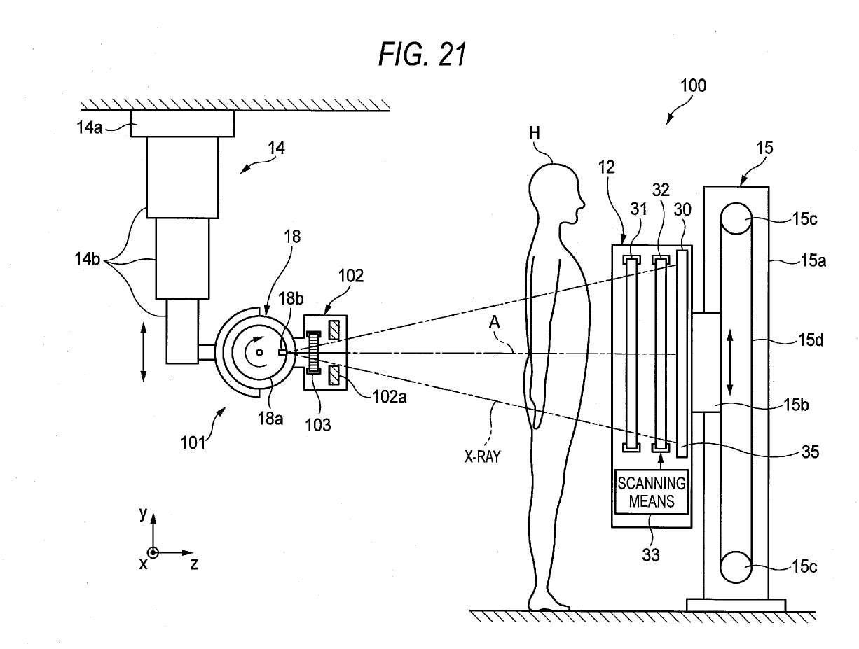

The first and second absorption type gratings 110, 111 and the FPD 112 of this illustrative embodiment can be applied to any of the above illustrative embodiments. Further, it may be possible that the multi-slit 103 (refer to FIG. 21) has the same shape as the first and second absorption type gratings 110, 111.

In the above illustrative embodiments, the piezoelectric actuator and the ball screw and step motor have been exemplified as the driving means for relatively moving the first and second gratings. In addition to this, an ultrasonic motor, an inertial driving piezoelectric actuator and the like may be also adopted as the driving means. The vibration that is generated when scanning the grating by the driving means can be controlled by the plurality of elastic members having different natural frequencies, as described above.

FIG. 18 shows another example of a radiographic system for illustrating an illustrative embodiment of the invention.

According to the respective X-ray imaging systems, it is possible to acquire a high contrast image (phase contrast image) of an X-ray weak absorption object that cannot be easily represented. Further, to refer to the absorption image in correspondence to the phase contrast image is helpful to the image reading. For example, it is effective to superimpose the absorption image and the phase contrast image by the appropriate processes such as weighting, gradation, frequency process and the like and to thus supplement a part, which cannot be represented by the absorption image, with the information of the phase contrast image. However, when the absorption image is captured separately from the phase contrast image, the capturing positions between the capturing of the phase contrast image and the capturing of the absorption image are deviated to make the favorable superimposition difficult. Also, the burden of the object to be diagnosed is increased as the number of the imaging is increased. In addition, in recent years, a small-angle scattering image attracts attention in addition to the phase contrast image and the absorption image. The small-angle scattering image can represent a tissue characterization caused due to the fine structure in the photographic subject tissue. For example, in fields of cancers and circulatory diseases, the small-angle scattering image is expected as a representation method for a new image diagnosis.

Accordingly, the X-ray imaging system of this illustrative embodiment uses a calculation processing unit 190 that enables the absorption image and the small-angle scattering image to be generated from a plurality of images acquired for the phase contrast image. Since the other configurations are the same as the above X-ray imaging system 10, the descriptions thereof are omitted. The calculation processing unit 190 has a phase contrast image generation unit 191, an absorption image generation unit 192 and a small-angle scattering image generation unit 193. The units perform the calculation processes, based on the image data acquired at the M scanning positions of k=0, 1, 2, . . . , M−1. Among them, the phase contrast image generation unit 191 generates a phase contrast image in accordance with the above-described process.

The absorption image generation unit 192 averages the image data Ik(x, y), which is obtained for each pixel, with respect to k, as shown in FIG. 19, and thus calculates an average value and images the image data, thereby generating an absorption image. Also, the calculation of the average value may be performed by averaging the image data Ik(x, y) with respect to k. However, when M is small, an error is increased. Accordingly, after fitting the image data Ik(x, y) with a sinusoidal wave, an average value of the fitted sinusoidal wave may be calculated. In addition, when generating the absorption image, the invention is not limited to the using of the average value. For example, an addition value that is obtained by adding the image data Ik(x, y) with respect to k may be used inasmuch as it corresponds to the average value.

The small-angle scattering image generation unit 193 calculates an amplitude value of the image data Ik(x, y), which is obtained for each pixel, and thus images the image data, thereby generating a small-angle scattering image. Also, the amplitude value may be calculated by calculating a difference between the maximum and minimum values of the image data Ik(x, y). However, when M is small, an error is increased. Accordingly, after fitting the image data Ik(x, y) with a sinusoidal wave, an amplitude value of the fitted sinusoidal wave may be calculated. In addition, when generating the small-angle scattering image, the invention is not limited to the using of the amplitude value. For example, a variance value, a standard error and the like may be used as an amount corresponding to the non-uniformity about the average value.

According to the X-ray imaging system of this illustrative embodiment, the absorption image or small-angle scattering image is generated from the plurality of images acquired for the phase contrast image of the photographic subject. Accordingly, the capturing positions between the capturing of the phase contrast image and the capturing of the absorption image are not deviated, so that it is possible to favorably superimpose the phase contrast image and the absorption image or small-angle scattering image. Also, it is possible to reduce the burden of the photographic subject, compared to a configuration in which the imaging is separately performed so as to acquire the absorption image and the small-angle scattering image.

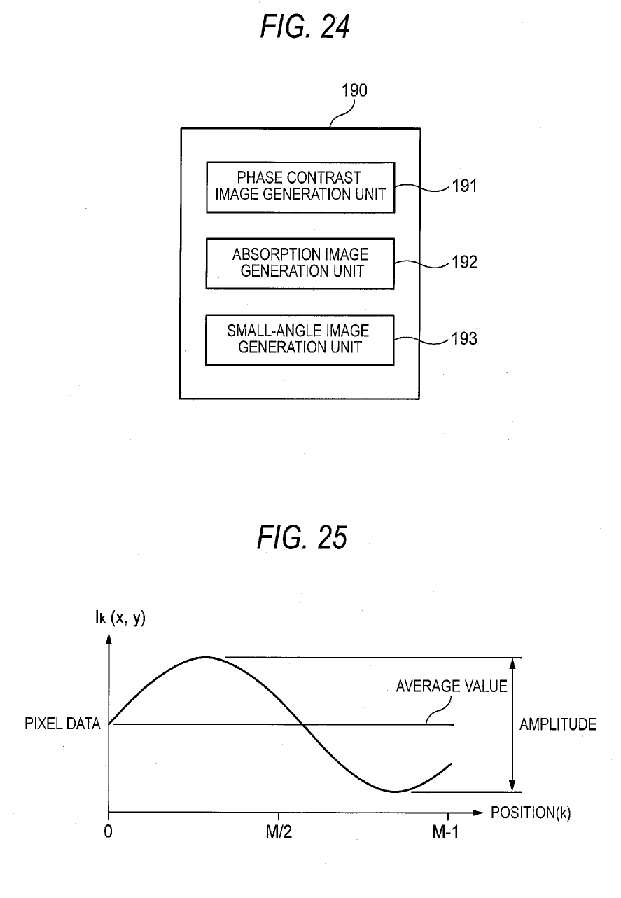

FIG. 24 shows another example of a radiographic system for illustrating an illustrative embodiment of the invention.

According to the respective X-ray imaging systems, it is possible to acquire a high contrast image (phase contrast image) of an X-ray weak absorption object that cannot be easily represented. Further, to refer to the absorption image in correspondence to the phase contrast image is helpful to the image reading. For example, it is effective to superimpose the absorption image and the phase contrast image by the appropriate processes such as weighting, gradation, frequency process and the like and to thus supplement a part, which cannot be represented by the absorption image, with the information of the phase contrast image. However, when the absorption image is captured separately from the phase contrast image, the capturing positions between the capturing of the phase contrast image and the capturing of the absorption image are deviated to make the favorable superimposition difficult. Also, the burden of the object to be diagnosed is increased as the number of the imaging is increased. In addition, in recent years, a small-angle scattering image attracts attention in addition to the phase contrast image and the absorption image. The small-angle scattering image can represent a tissue characterization caused due to the fine structure in the photographic subject tissue. For example, in fields of cancers and circulatory diseases, the small-angle scattering image is expected as a representation method for a new image diagnosis.

Accordingly, the X-ray imaging system of this illustrative embodiment uses a calculation processing unit 190 that enables the absorption image and the small-angle scattering image to be generated from a plurality of images acquired for the phase contrast image. Since the other configurations are the same as the above X-ray imaging system 10, the descriptions thereof are omitted. The calculation processing unit 190 has a phase contrast image generation unit 191, an absorption image generation unit 192 and a small-angle scattering image generation unit 193. The units perform the calculation processes, based on the image data acquired at the M scanning positions of k=0, 1, 2, . . . , M−1. Among them, the phase contrast image generation unit 191 generates a phase contrast image in accordance with the above-described process.

The absorption image generation unit 192 averages the image data Ik(x, y), which is obtained for each pixel, with respect to k, as shown in FIG. 25, and thus calculates an average value and images the image data, thereby generating an absorption image. Also, the calculation of the average value may be performed by averaging the image data Ik(x, y) with respect to k. However, when M is small, an error is increased. Accordingly, after fitting the image data Ik(x, y) with a sinusoidal wave, an average value of the fitted sinusoidal wave may be calculated. In addition, when generating the absorption image, the invention is not limited to the using of the average value. For example, an addition value that is obtained by adding the image data Ik(x, y) with respect to k may be used inasmuch as it corresponds to the average value.

The small-angle scattering image generation unit 193 calculates an amplitude value of the image data Ik(x, y), which is obtained for each pixel, and thus images the image data, thereby generating a small-angle scattering image. Also, the amplitude value may be calculated by calculating a difference between the maximum and minimum values of the image data Ik(x, y). However, when M is small, an error is increased. Accordingly, after fitting the image data Ik(x, y) with a sinusoidal wave, an amplitude value of the fitted sinusoidal wave may be calculated. In addition, when generating the small-angle scattering image, the invention is not limited to the using of the amplitude value. For example, a variance value, a standard error and the like may be used as an amount corresponding to the non-uniformity about the average value.

According to the X-ray imaging system of this illustrative embodiment, the absorption image or small-angle scattering image is generated from the plurality of images acquired for the phase contrast image of the photographic subject. Accordingly, the capturing positions between the capturing of the phase contrast image and the capturing of the absorption image are not deviated, so that it is possible to favorably superimpose the phase contrast image and the absorption image or small-angle scattering image. Also, it is possible to reduce the burden of the photographic subject, compared to a configuration in which the imaging is separately performed so as to acquire the absorption image and the small-angle scattering image.

The above illustrative embodiments relate to the application in which the invention is applied to the medical diagnosis apparatus. However, the invention is not limited to the medical diagnosis apparatus and can be applied to the other radiation detection apparatus for industrial use.

As described above, the specification discloses a radiographic apparatus that includes:

a first grating;

a second grating having a period that substantially coincides with a pattern period of a radiological image formed by radiation having passed through the first grating;

a scanning means that relatively displaces the radiological image and the second grating to a plurality of relative positions at which phase differences between the radiological image and the second grating are different each other, and

a radiological image detector that detects the radiological image masked by the second grating,

wherein the scanning means includes a driving means that drives at least one of the first grating and the second grating relatively to the other in a pattern arrangement direction of the radiological image and a plurality of elastic members that has natural frequencies different from each other and presses the driving target of the driving means in a direction opposite to the driving direction.

Also, according to the radiographic apparatus disclosed in the specification, the respective natural frequencies of the elastic members do not have a relation of an integer multiple.

Also, according to the radiographic apparatus disclosed in the specification, the elastic members are symmetrically arranged about a central line passing to an operating point of the driving means and extending in the driving direction.

Also, according to the radiographic apparatus disclosed in the specification, the elastic members include elastic members that are provided for each type based on the difference of the natural frequencies, and the elastic members of the same type are symmetrically arranged about the central line.

Also, according to the radiographic apparatus disclosed in the specification, the elastic members include a first elastic member that is provided on a central line passing to an operating point of the driving means and extending in the driving direction and a second elastic member that is provided at an inner side of the first elastic member.

Also, according to the radiographic apparatus disclosed in the specification, an amount of relative displacement between the radiological image by the scanning means and the second grating corresponds to a section that is made by dividing the pattern period of the second grating into 3 or more.

Also, according to the radiographic apparatus disclosed in the specification, the radiation is a cone beam having an irradiation range that is enlarged in proportion to a distance from a radiation focus, and the driving target is the second grating.

Also, according to the radiographic apparatus disclosed in the specification, the driving means includes a piezoelectric device that transfers displacement, which is caused when applying a voltage, to the driving target.

Also, according to the radiographic apparatus disclosed in the specification, the driving means includes a ball screw having a screw shaft and a nut fitted on the screw shaft and fixed to the driving target and a step motor that rotates the screw shaft.

Also, according to the radiographic apparatus disclosed in the specification, the driving target is held by the driving means and the elastic members, which are respectively arranged at both end sides in the driving direction.

Also, according to the radiographic apparatus disclosed in the specification, a radiation source for irradiating the radiation toward the first grating is further provided.

Also, the specification discloses a radiographic system including a calculation processing unit that calculates, from an image detected by the radiological image detector of the radiographic apparatus, a distribution of refraction angles of the radiation incident onto the radiological image detector and generates a phase contrast image of a photographic subject based on the distribution of the refraction angles.

What is claimed is:

1. A radiographic apparatus comprising:
a first grating;
a second grating that includes a periodic form that has a period which substantially coincides with a pattern period of a radiological image formed a radiation having passed through the first grating;
a scanning unit that relatively displaces the radiological image and the second grating to a plurality of relative positions at which phase differences between the radiological image and the second grating are different each other, and
a radiological image detector that detects a masked radiological image which is formed by masking the radiological image by the second grating,
wherein the scanning unit includes a driving unit that drives at least one of the first grating and the second grating relatively to the other in a pattern arrangement direction of the radiological image and a plurality of elastic members that has natural frequencies different from each other and presses the driving target of the driving means in a direction opposite to a driving direction of the driving unit.

2. The radiographic apparatus according to claim 1, wherein the respective natural frequencies of the elastic members do not have a relation of an integer multiple.

3. The radiographic apparatus according to claim 1, wherein the elastic members are symmetrically arranged about a central line passing to an operating point of the driving unit and extending in the driving direction.

4. The radiographic apparatus according to claim 3, wherein the elastic members include elastic members that are provided for each type based on the difference of the natural frequencies, and
wherein the elastic members of the same type are symmetrically arranged about the central line.

5. The radiographic apparatus according to claim 1, wherein the elastic members include a first elastic member that is provided on a central line passing to an operating point of the driving unit and extending in the driving direction and a second elastic member that is provided at an inner side of the first elastic member.

6. The radiographic apparatus according to claim 1, wherein an amount of relative displacement between the radiological image by the scanning unit and the second grating corresponds to a section that is made by dividing the pattern period of the second grating into 3 or more.

7. The radiographic apparatus according to claim 1, wherein the radiation is a cone beam having an irradiation range that is enlarged in proportion to a distance from a radiation focus, and
wherein a driving target of the driving unit is the second grating.

8. The radiographic apparatus according to claim 1, wherein the driving unit comprises a piezoelectric device that transfers displacement, which is caused when applying a voltage, to the driving target.

9. The radiographic apparatus according to claim 1, wherein the driving unit comprises a ball screw having a screw shaft and a nut fitted on the screw shaft and fixed to the driving target and a step motor that rotates the screw shaft.

10. The radiographic apparatus according to claim 1, wherein a driving target of the driving unit is held by the driving unit and the elastic members, which are respectively arranged at both end sides in the driving direction.

11. The radiographic apparatus according to claim 1 further comprising a radiation source for irradiating the radiation toward the first grating.

12. A radiographic system comprising:
the radiographic apparatus according to claim 1, and
a calculation processing unit that calculates, from an image detected by the radiological image detector of the radiographic apparatus, a distribution of refraction angles of the radiation incident onto the radiological image detector and generates a phase contrast image of a photographic subject based on the distribution of the refraction angles.
